(19) United States
(12) Patent Application Publication
(10) Pub. No.: US 2002/0022973 A1
(43) Pub. Date: Feb. 21, 2002

(54) Medical information management system and patient interface appliance

(76) Inventors: Jianguo Sun, Belmont, CA (US); Robert D. Crouch, Monroeville, PA (US); Eugene N. Scarberry, Trafford, PA (US); William J. Kaigler, North Huntingdon, PA (US); Julia Tverskaya, Palo Alto, CA (US); Kenny Chitai Huang, Sunnyvale, CA (US); Andrew Kwok, Freemont, CA (US)

Correspondence Address: Michael W. Haas, Respironics, Inc., 1501 Ardmore Boulevard, Pittsburgh, PA, 15221-4401, US

(21) Appl. No.: 09/814,143

(22) Filed: Mar. 21, 2001

Related U.S. Application Data
(60) Provisional application No. 60/192,071, filed on Mar. 24, 2000.

(51) Int. Cl. G06F 17/60

(52) U.S. Cl. 705/3

(57) ABSTRACT

A medical information management system and method that stores and manages patient information and that enables a patient and an authorized third party, such as a friend or family member, to access the patient's medical information. The presentation format, substance of the patient's medical information provided, or both are customized depending on whether the patient, a healthcare professional or the third party is accessing the patient's medical information. The present invention also pertains to a method of subsidizing such a medical information system by selling advertising space in the presentation shown to the third party, patient, or the healthcare professional. The present invention further pertains to a patient interface appliance that includes a display containing multiple viewing fields, one of which is a general information field and one of which is an advertising field, to present information and advertisements to a user during a patient interactive session. Patient participation in conducting the survey is fostered by offering a survey completion reward to the patient upon completing the survey.

### CROSS-REFERENCES TO RELATED APPLICATIONS

This application claims priority under 35 U.S.C. § 119(e) from provisional U.S. patent application Ser. No. 60/192,071 filed Mar. 24, 2001.

### BACKGROUND OF THE INVENTION

1. Field of the Invention

The present invention pertains to a medical information management system and method that stores and manages patient information and that enables a patient, a healthcare provider, and an authorized third party, such as a friend or family member of the patient, to access that patient's medical information, with a unique presentation format being presented for each category of user. The present invention also pertains to method of subsidizing such a medical information management system.

The present invention further pertains to patient interface appliance having multiple viewing fields, one of which is a general information field and one of which is an advertising field, to present information and advertisements to a user. The patient interface device can be used to interact with in any information management system, including the above-described system.

The present invention still also pertains to a patient interface appliance that is used by the patient interact with the management system and that provides a reward to user for interacting with the system, thereby encouraging use of the patient interface appliance and interaction with the patient information management system.

2. Description of the Related Art

It is common for a patient requiring long term medical treatment or monitoring to do so on an outpatient basis, with the patient typically being located at his or her home. This presents a challenge in ensuring that the patient is complying with the medical treatment, such as taking his or her medications or using any prescribed therapy or treatment devices when directed and in the proper manner. For example, a patient suffering from obstructive sleep apnea (OSA) is typically prescribed a pressure support therapy, such as a continuous positive airway pressure (CPAP) treatment, that is to be used nightly. The challenge exists in ensuring that the patient uses this CPAP treatment each night.

Another challenge exists in ensuring that the patient performs any recommended monitoring function as directed, and accurately reports the results to the caregiver. For example, it is important for a diabetic to monitor his or her glucose level and to do so accurately. A patient suffering from congestive heart failure (CHF) is typically instructed to monitor his or her weight regularly. Patient's with a pulmonary disease or disorder, such as asthmatics or those suffering from chronic obstructive pulmonary disease (COPD), may periodically perform a pulmonary function test to monitor the condition of their respiratory system.

Ensuring that such patients perform these tests at the right time, in the right manner, and report the results correctly is a primary concern in an outpatient situation. This is a special concern for insurance companies or government reimbursement agencies, who understandably want its patients to comply with their prescribed treatments for which the insurance company or government agency is reimbursing the physician or medical device provider. Of course, it is also in the patient's best interests to take their medication in the correct amount at the appropriate time, for example.

Oftentimes the friends or family members of the patient take an active role in meeting these challenges. Indeed, it is estimated that approximately one out of every four households in the United States includes a person who assumes the responsibility of caring for a family member or friend. However, it becomes increasingly difficult for the friend or family member to maintain an active role in caring for a patient if the two are geographically separated, which is also becoming more common as society becomes more mobile and more willing to relocate far from established family regions.

As a consequence, in order for a daughter living in the northeast to check on a parent living in the southwest, for example, she must either travel across the country, which is expensive and time consuming, or keep in contact the parent using conventional communication techniques, such as telephone, e-mail, fax, etc. This latter approach may not provide the daughter with a clear and complete picture of the parent's medical condition and may not allow for timely review of the patient by the third party. For example, the daughter may not be able to get the parent on the phone, and e-mail and fax can have significant time delays between the time the e-mail in sent and the time the fax is received and responded to, if at all.

For these reasons, conventional techniques may not sufficiently inform the daughter as to how well the parent is complying with a prescribed treatment, and provides only a limited picture of the patient's ongoing progress. This problem is exacerbated if the patient's ability to understand or communicate information to the third party caregiver, typically the friend of family member, regarding their medical condition or treatment is limited or impaired.

Telemedicine is an increasingly popular technique that allows a health professional, such as doctor or nurse, to monitor the condition of a patient outside the hospital or doctor's office. FIG. 1 schematically illustrates a conventional telemedicine system 10 in which a number of patients 12 communicate with an information management system 14, for example, a computer system capable of storing patient medical information. Patients 12 provide their medical information to information management system 14 by manually entering the information via an interface device, such as a computer or telephone. For example, a diabetic patient may enter information concerning their glucose level, the time that the glucose level was taken, the dosage of insulation taken, and the time that the dosage was administered.

This information is transmitted by the input device to information management system 14. It is also known to collect patient information using a monitoring device, with the monitoring device directly communicating or downloading its data to information management system 14. The patient typically can assess the information management system to review their medical information, such as their prescribed medications and instructions for taking the medication, as well as any other information made available to them through the information management system, such as general, non-specific medical information concerning a variety of topics, such as disease information and drug interaction.

Healthcare professionals 16, such as doctors, nurses, specialists, therapists, lab technicians and other professionals involved in the field of healthcare, also interact with information management system 14, for example, to review the collected patient information, add or modify patient information, change or modify medical treatments provided to the patient, or a combination of these functions, depending on the user's authority to make such changes or recommendations. For present purposes, the term “healthcare professionals” includes medical insurance companies and agencies responsible for reimbursing the medical providers for their serves or products. Communication links 18 between patients 12, healthcare professionals 16, and information management system 14 are established using any conventional communication technique or protocol, such as by means of the internet or a telephone.

While telemedicine is believed to be helpful in improving interaction and monitoring of a home-based patient by the healthcare professional, it does nothing to foster the involvement of the friend or family member in monitoring and caring for the patient. At best, the friend or family member can access the telemedicine system as if they were the patient or as if they were healthcare professional, e.g., by using the patient's or healthcare professional's username and password, to review the same patient information contained in the information management system 14 that the patient or healthcare professional can access, if such information is available. In essence, the friend or family member can, at best, step into the shoes of the patient or healthcare professional, assuming, of course, that such a friend or family member has the appropriate authorization to do so, as medical records are treated as confidential between a doctor and a patient.

Unfortunately, the patient information that the friend or family member can access by stepping into the shoes of the patient may be of little or no use in helping that person determine if the patient is complying with the prescribed treatments or performing the recommended monitoring. Likewise, the patient information that the friend or family member can access by stepping into the shoes of the healthcare professional is likely to be of little or no use to a layperson who lacks a detailed knowledge of the meaning of such information.

While the practice of telemedicine is also generally more convenient and economical than keeping the patient in the hospital, the conventional form of telemedicine places a significant burden on the healthcare professional and the patient. For example, the healthcare professional or patient must remember to contact the other party. This requires that the healthcare professional, for example, have a calendering capability and sufficient staff to communicate with their patients according to each patient's monitoring schedule. If a live audio, live video, or other direct communication system is used between the patient and healthcare professional, both parties must be available at the same time and have access to the appropriate communication equipment to interact with one another. If e-mail or other stored information transmission mode is used to communicate between the parties, it requires that the patient, as well as the caregiver, have a working knowledge and access to a computer and a communication link, such as the world wide web. Facsimile and video communications system also require that relatively complicated and expensive equipment be available to the patient at home and to the healthcare provided and that the both users be trained in its use.

It is known to provide a dedicated communication terminal in the patient's home, which the patient uses to complete a survey regarding their medical condition. The results of the survey are collected by the communication terminal and periodically downloaded by the terminal to a data center so that the results can be accessed by a healthcare professional to monitor the patient's medical condition. The Health Buddy® appliance and network provided by Heath Hero Network, Inc. of Mountain View, Calif., is an example of such a system, which is essentially a stored information transmission system. See also U.S. Pat. No. 5,897,493.

While this telemedicine technique may offer certain advantages for the healthcare professional, it also has significant disadvantages. For example, this telemedicine technique places a significant cost burden on the enterprise seeking to establish and maintain the communication system, in that the capitol expenditure needed to provide the dedicated communication terminal in each patient's house and the ongoing network administration costs are relatively large. While these costs may be born by this enterprise, typically, these costs are passed down to the patients or to the patients' insurance providers or government agency responsible for medical reimbursements. In addition, this telemedicine technique, as well as the other telemedicine techniques discussed above, exclude access of other parties to the patient population being serviced by the telemedicine network, because this technique does not optimize the information communication function of the communication terminal due to its limited presentation of information to the user. For example, the communication terminal excludes parties, other than the network administrator, such as medical service providers, medical device manufactures, and pharmaceutical companies, from presenting information to the patients subscribing to the communication network. Such information from third parties, if known to the patient, can be of value to the patient.

### SUMMARY OF THE INVENTION

Accordingly, it is an object of the present invention to provide a medical information management system that overcomes the shortcomings of conventional systems. This object is achieved according to one embodiment of the present invention by providing a medical information management system that includes an information management center for receiving, storing, and managing medical information associated with a patient. A patient communicates with the information management center, either directly (real-time) or indirectly (not real time) via a first communication link to allow the patient to access the medical information, for example, for updating this information. The interaction between the patient and the information management system, whether through direct interaction with the information management center or by interacting with the patient appliance that subsequently communicates with the information management center via the first communication link, is governed by a patient-management center protocol, so that the patient is provided with a patient tailored presentation during his or her interaction.

A healthcare professional terminal of a healthcare professional supervising a patient whose medical information is being managed by the information management center, such as the patient's doctor, nurse, insurer, or HMO, also communicates with the information management center via a second communication link. This allows the healthcare professional to review, for example, the medical history and treatment plan of a patient. The interaction between the healthcare professional terminal and the information management center is governed by a healthcare professional-management center protocol, so that the healthcare professional is provided with a healthcare professional tailored presentation during their interaction with the information management center. This healthcare professional tailored presentation is different from the patient tailored presentation, and is specifically designed to provide information particularly relevant to the those in the healthcare industry.

A third party terminal of a third party, who is authorized by a patient whose medical information is being managed by the information management center, can also establish a third communication link with the information management center. This third communication link allows the third party access to the patient's medical information, for example, to review whether the patient has complied with the prescribed medical treatment. Interaction between the third party terminal and the information management center via the third communication link is governed by a third party-management center protocol so that the third party is provided with a third-party tailored presentation while interacting with the information management center. This third-party tailored presentation is different from the patient tailored presentation and is different from the healthcare professional tailored presentation.

It can thus be appreciated that the medical information management system of the present invention allows a third party, such as a friend of family member of a patient using the system, to access the medical information for that patient so that the third party can again take an active role in caring for the patient. Furthermore, this is done in such a manner that the third-party is provided with information in a format that is best suited that person, and not merely a duplication of the presentation format provided to the patient or the healthcare professional.

It is yet another object of the present invention to provide a method of managing medical information that does not suffer from the disadvantages associated with conventional medical information management techniques. This object is achieved by providing a method for using the above-described medical information management system to allow the patient, healthcare professional, and an authorized third party to access the medical information for that patient so that each different type of user is presented with a presentation particularly suited to their needs.

It is a still further object of the present invention to provide a method of subsidizing the costs associated with initiating and operating a medical information management system. This object is achieved by providing an advertisement field in the third party tailored presentation, the patient tailored presentation, and/or the healthcare professional tailored presentation in the above-described medical information management system. Use or access to this advertisement field can be sold to others so that the advertisement field purchaser can present advertisements or other information to the patient, third party, or healthcare professional while the patient, third party or healthcare professional accesses the medical information management system.

It is a still further object of the present invention to provide a patient interface appliance that is capable of displaying advertisements in addition to the medically related information for use in a medical information management system. This object is achieved, according to one embodiment of the present invention, by providing a patient interface appliance that includes a housing containing an input device, a display, and a processor. The processor receives input information from the input device and controls the presentation of information provided on the display such that the display includes a general information field and an advertisement field. The patient interface appliance also includes a memory associated with the processor for storing data including query display commands, the input information, and advertisement display commands. The query display commands cause queries pertaining to a patient's medical condition to be presented in the general information field in a patient survey. The advertisement display command causes an advertisement to be displayed in the advertisement field so that the patient is presented with both advertisements and information and/or queries during an interactive session with the patient interface appliance. In addition, the patient interface appliance includes the ability to communicate information from the patient interface appliance to a medical information management center.

By providing both queries and advertisements to the patient, the interface appliance of the present invention provides a mechanism for the enterprise managing the information network that uses the patient interface appliance to generate revenue through the sale of such advertisements, thereby helping to defray the costs associated with establishing and/or managing the information network. These advertisements also provide companies a communication channel by which to access to patients using the patient interface appliance, which is beneficial to such companies in that they can directly promote their products or services to the patients. These advertisements are also beneficial to the patients, because the patients are presented with information, such as product and service ideas, that may be of value and interest.

It is a still further object of the present invention to provide a method of monitoring a patient using the above-described patient interface appliance. This object is achieved by providing a method that includes (1) providing the patient interface appliance having a display, a memory, and an input device, (2) storing in the memory of the appliance query display commands, input information entered into the appliance in response to a query, and an advertisement display command, (3) displaying an advertisement in an advertisement field of the display based on the advertisement display command, and (4) displaying a patient survey comprising a plurality of queries in the general information field based on the query display commands. The method also includes (5) receiving input information from the patient via the input device for each query presented and (6) transmitting the input information to a medical information management center via the communication terminal.

It is a still further object of the present invention to provide a medical patient interface appliance and method for using such as device that provides an incentive for the patient to use the appliance, for example, to complete a periodic wellness survey. This object is achieved according to one embodiment of the present invention by providing a patient interface appliance that includes a housing, an input device, a display, and a processor. The processor receives input information from the input device and controls the presentation of information provided on the display. This device enables a patient survey to be provided to the user where a plurality of queries pertaining to a patient's medical condition are presented on the display. The patient's response to each query are stored in a memory for immediate or later transmission to a patient management center, so that a caregiver can keep updated as to the patient's wellness. Upon completing the patient survey, the processor provides a user with a survey completion reward, thereby motivating the user to complete the survey, as directed.

These and other objects, features and characteristics of the present invention, as well as the methods of operation and functions of the related elements of structure and the combination of parts or components and economies of manufacture and use, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a schematic diagram of a conventional telemedicine system;

FIG. 2 is a schematic diagram of a medical information management system according to the principles of the present invention;

FIG. 3 is a more detailed schematic diagram of the medical information management system of FIG. 2;

FIG. 4 is a schematic diagram of a patient interface appliance for use in the medical information management system of FIG. 3 as well as other management systems;

FIGS. 5A-5M illustrate an example of a display presentation tailored for use when a healthcare provider interacts with the medical information management system;

FIGS. 6A-6B illustrate an example of a display presentation tailored for use when an authorized third party interacts with the medical information management system;

FIGS. 7A-7G illustrate an example of a dedicated patient interface appliance for use with the medical information management system and a display presentation provided on this device that is tailored for use when a patient interacts with the medical information management system;

FIG. 8 illustrates an algorithm for operating the patient interface appliance according to the principles of the present invention; and

FIG. 9 illustrates an algorithm for maintaining the patient interface appliance in a stand-by mode.

### DETAILED DESCRIPTION OF THE PRESENTLY PREFERRED EMBODIMENTS OF THE INVENTION

FIG. 2 schematically illustrates an exemplary embodiment of a medical information management system 30 according to the principles of the present invention, and FIG. 3 is a more detailed schematic diagram of the medical information management system. At the center of medical information management system 30 is an information management center 32, which is a computer based information management system capable of storing, collecting, and processing patient medical and biographical information. In one embodiment of the present invention, information management center 32 is a database and processor hub, collectively referred to as a server 34, as shown in FIG. 3. Accessing server 34 is possible from a remote location via any conventional communication technique, such as via the internet.

The present invention also contemplates configuring information management center 32 to include multiple servers 34 that communicate with one another using any conventional technique, with the entire collection of servers, or a portion of the collection of servers, defining information management center 32. All of the servers defining the information management center can be located at a single location or interspersed at multiple geographic locations. Access to this latter configuration for the information management center 32 can be achieved by accessing any one of the servers using any conventional communication technique. In a preferred exemplary embodiment of the present invention, information management center 32 is located at a base site and interaction with the base site is achieved using the internet, which is accessed via a computer or other internet accessible device.

As shown in FIG. 2, each patient 12 subscribing to the medical information management system of the present invention interacts with information management center 32 via a first communication link 36. The information management center contains information about each patient that subscribes to this system and, in particular, medical information concerning, for example, the patient's past medical history, current medical conditions and treatments, and information concerning the patient's compliance with the medical treatment. Information management center 32 can also contain patient biographical information, and information that is continuously or periodically collected from the patient or from a monitoring device used by the patient. Such information may include, health related data collected in response to queries posed to the patient. It can also include patient physiological data, which is any data about the condition of the patient, collected via a medical monitoring device used by the patient. Data collected by a healthcare professional supervising that patient can also be provided to the system. For example, a physician may download patient medical information collected during an office visit by that patient.

Preferably, the authority to access the information the information management system for the purpose of changing or adding data to the patient's medical information is limited, for example, to a patient information administrator. This is done to prevent inadvertent or unauthorized alteration of the patient's medical information. Thus, the physician may provide patient medical information collected during an office visit by that patient to the information administrator for updating the information contained in the information management system.

Each healthcare professional 16 participating in the medical information management system of the present invention interacts with management center 32 via a second communication link 38. This enables the healthcare professional to review the patient medical information, update the information (if authorized), and provide recommendations to the patient, for example.

The medical information management system of the present invention also allows a non-healthcare professional third party 40, who has received authorization from the patient, to participate in the system by interacting with information management center 32 via a third communication link 42. This allows a third party, such as a friend or family member of a patient, to monitor the ongoing treatment of a patient by reviewing that patient's medical information, even if the third party is hundreds or thousands of miles from the patient.

Of importance with respect to the information management system of the present invention is that each user accessing the information management center is presented with information that is meaningful to that user, and that this information is presented in a manner that is best suited for that category of user. For example, a healthcare provider accessing the information management system should have the ability to review, in detail, the medical information, both past and ongoing, of all of the patients under their supervision and that subscribe to the information management system. It can be appreciated that the level of detail in the patient's medical information available to the healthcare professional should be relatively high so that the healthcare professional can make a complete and informed assessment of the patient's condition.

Conversely, a patient or an authorized third party interacting with the information management system may be confused if the medical information is presented using terms, charts, or other presentation techniques that are not familiar to a layperson. For this reason, the interaction between the healthcare professional and the information management center via the second communication link is governed by a healthcare professional-management center protocol, so that a healthcare professional interacting with the information management center is provided with a healthcare professional tailored presentation. On the other hand, the interaction between the authorized third party or patient and the information management system is governed by a protocol that is different from that used by the healthcare professional, so that the presentation given to a patient or third party interacting with the information management center is better suited to their level of sophistication. Namely, the presentation of medical information or the interaction process between information management center and the patient or third party is tailored to be readily understood by a layperson.

The present inventors also recognized that the information of interest to a patient may not be of interest to a third party. For example, a patient may be interested to be reminded when to take the medication, while a third party may be interested to know only that the medication was taken. For this reason, information management center 32 governs its interaction with the patient according to a patient-management center protocol, so that a patient interacting with the information management center is provided with a patient tailored presentation. On the other hand, information management center 32 governs its interaction with the third party according to a third party-management center protocol, so that the third party interacting with the information management center is provided with a third party tailored presentation that is different from the patient tailored presentation.

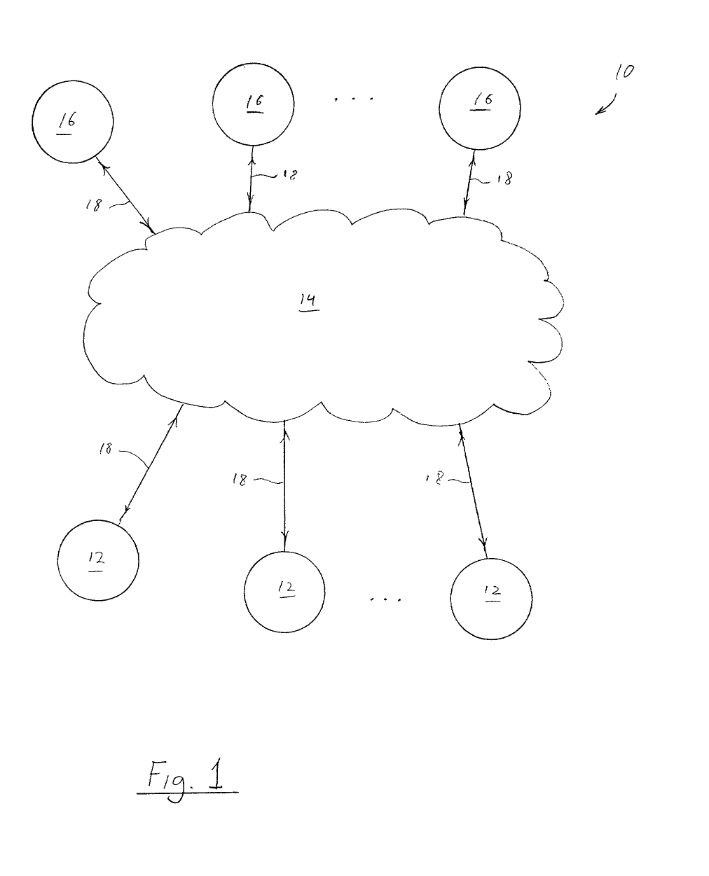

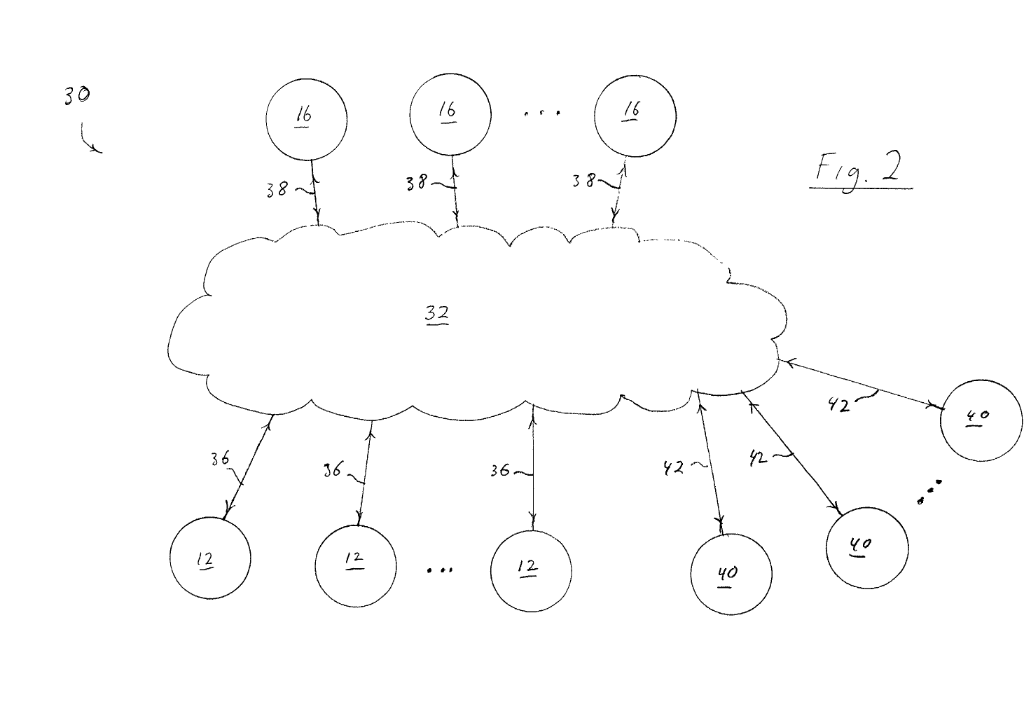

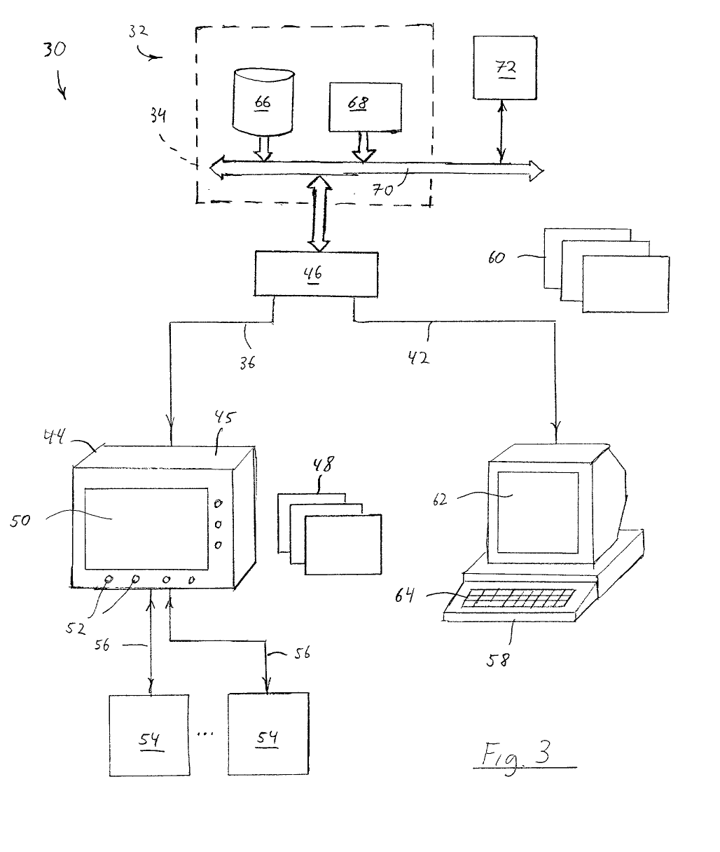

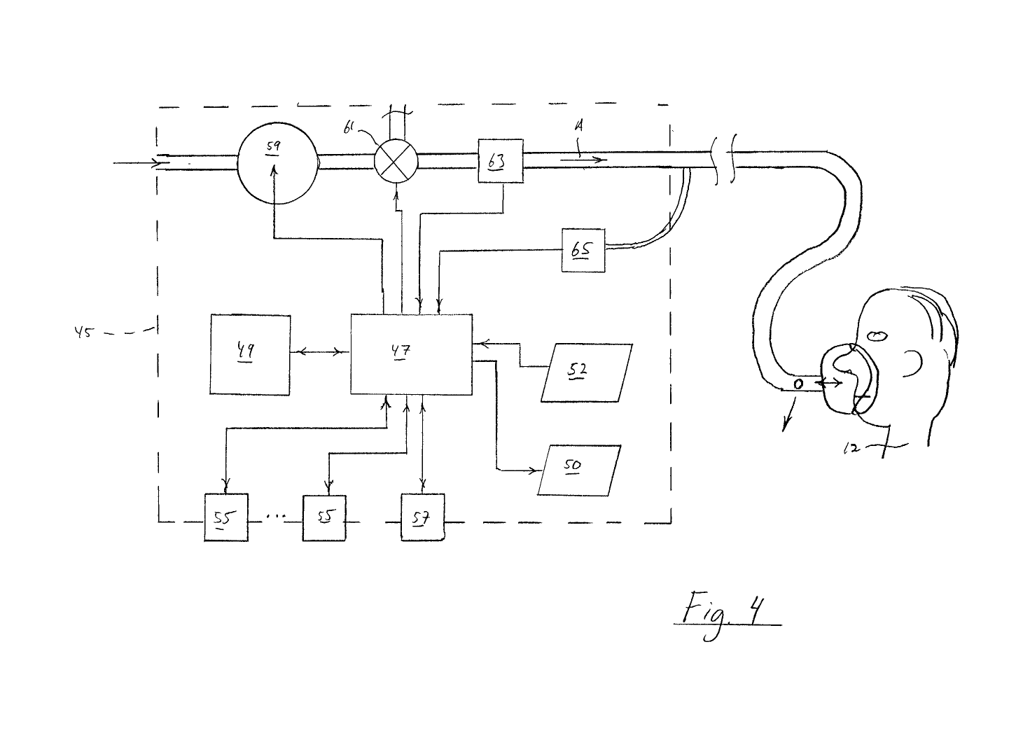

FIG. 3 shows a detailed schematic diagram of medical information management system 30, and FIG. 4 shows a detailed schematic diagram of an exemplary embodiment of a patient interface appliance that can be used in the medical information management system of FIG. 3. In this exemplary embodiment, patient 12 interacts with server 34 via first communication link 36 using a patient interface appliance 44, which in a preferred embodiment of the present invention, is a portable, hand-held device that is capable of periodically establishing the first communication link with the server. More specifically, patient interface appliance 44 preferably runs a predetermined processing routine that is stored in the unit. Based on this routine, a patient-tailored presentation 48 is presented to the user under the control of the program stored in the appliance.

Periodically, patient interface appliance 44 synchronizes with server 34 through a communication network 46, such as a conventional telephone system or cable system commonly used to provide internet service to the home. This can be done automatically by the appliance after the patient has provided data into the appliance, after a predetermined amount of data has be loaded into the appliance, or periodically, such as in the middle of the night or other time when the patient is not using the appliance. Once first communication link 36 between patient interface appliance 44 and server 34 is established, server 34 preferably controls the exchange of information during this log-on session. In this manner, a patient interacts, at least indirectly, with the information management center and is provided with a patient tailored presentation 48 based on the reprogrammed routines stored in the patient appliance.

Patient interface appliance 44 includes a housing 45, a processor 47, a memory 49, a display 50, such as an LED or LCD, and at least one input device 52, such as buttons, keys, microphone, touch screen, pen, or mouse, for activating and operating the appliance as well as for using appliance 44 to interact with information management center 32. Housing 45 preferably contains these components as a small, hand-held, light weight portable unit that can be easily carried.

Memory 49 stores programs or commands to be executed by the patient interface appliance, information or indicia to be displayed by the display, and patient data collected by the appliance, such as data collected as a result of queries presented to the patient via display 50, the details of which are discussed below. Patient interface appliance 44 also includes a power supply (AC, DC, or both) and a communication terminal or interface 57, such as modem, for accessing a communication network 46, which is preferably the internet, to link the patient interface appliance to the medical information management center. Of course, memory 49 and processor 47, respectively, store and execute the routines necessary to communicate data over this network.

The present invention further contemplates that patient interface appliance 44 communicates with other medical equipment 54, such as a spirometer, scale, glucose monitor, temperature sensor, cardiac monitor, polysomnography system, or any other medical device or system that is capable of monitoring a physiological condition of a patient. In addition, the present invention contemplates that patient interface appliance 44 has the capability to interact with medical equipment 54 to receive data indicative of the use of the medical equipment or diagnostic data indicative of the condition of the medical device to alert the patient or others if the monitored parameters, such as operating temperature of the medical device, are not within established thresholds. To these ends, patient interface appliance 44 includes one or more medical equipment terminals 55, such as a serial communication port, to communicate with such devices via a medical device communication link 56. It should be noted that communication link 56 can be a hardwired or a wireless link, such as an rf or infrared link.

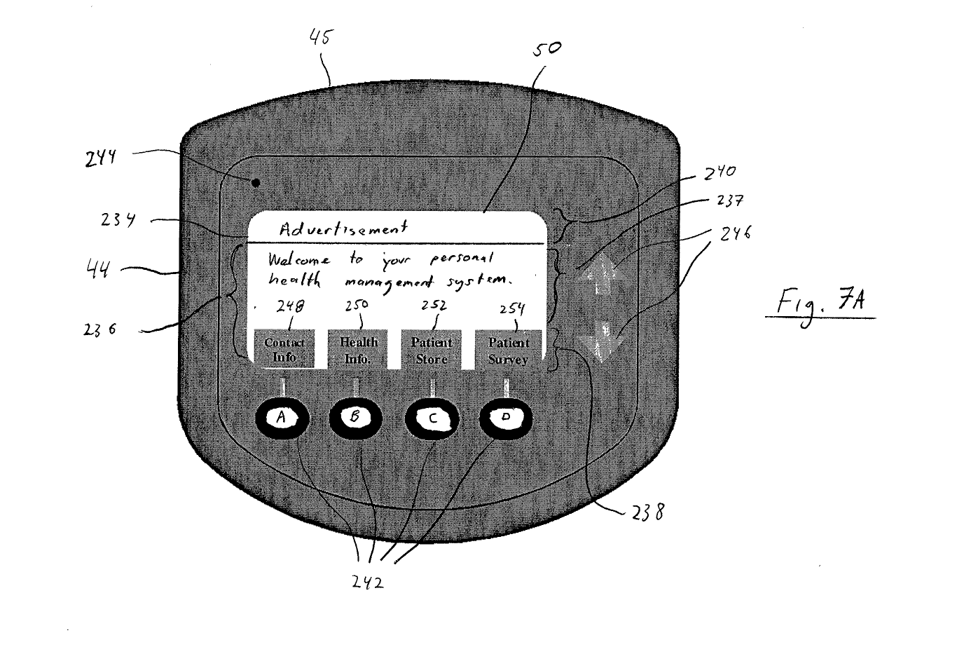

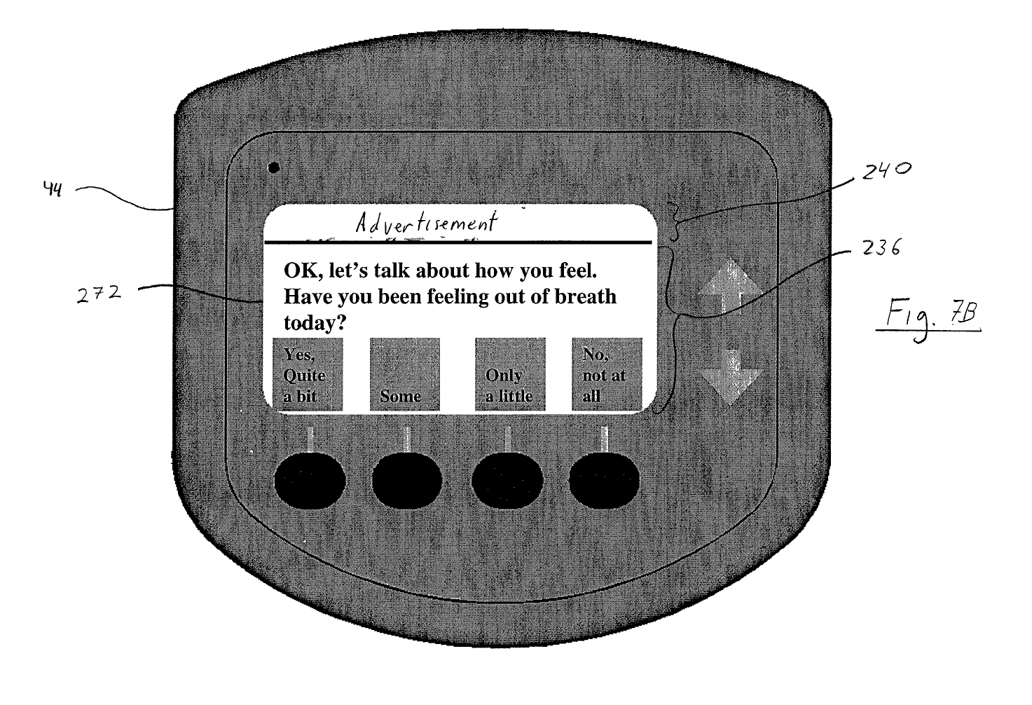

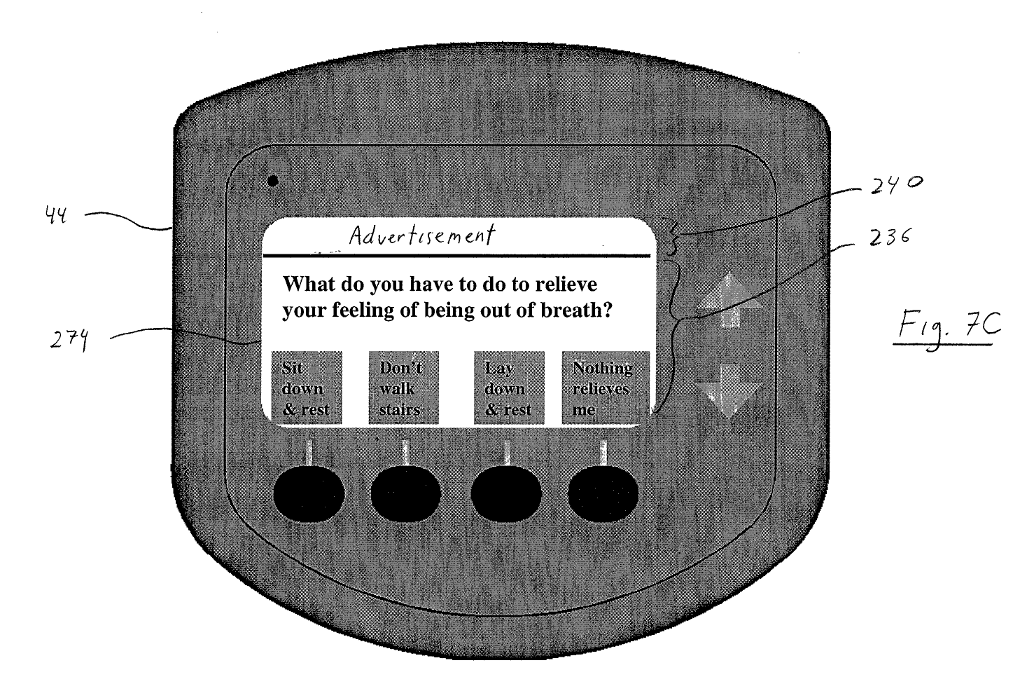

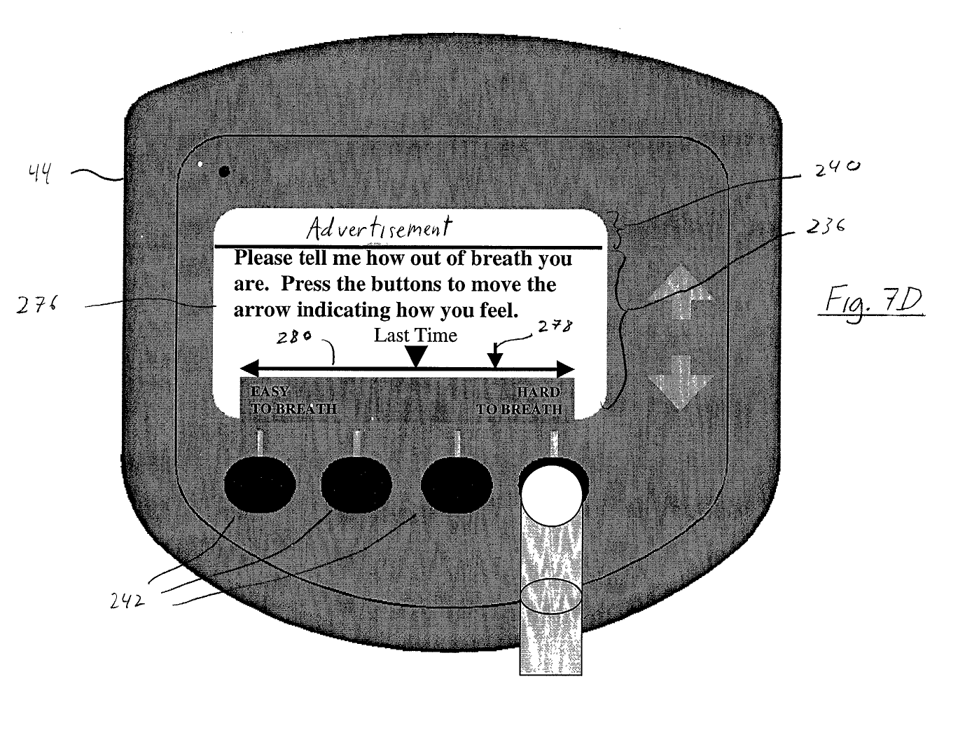

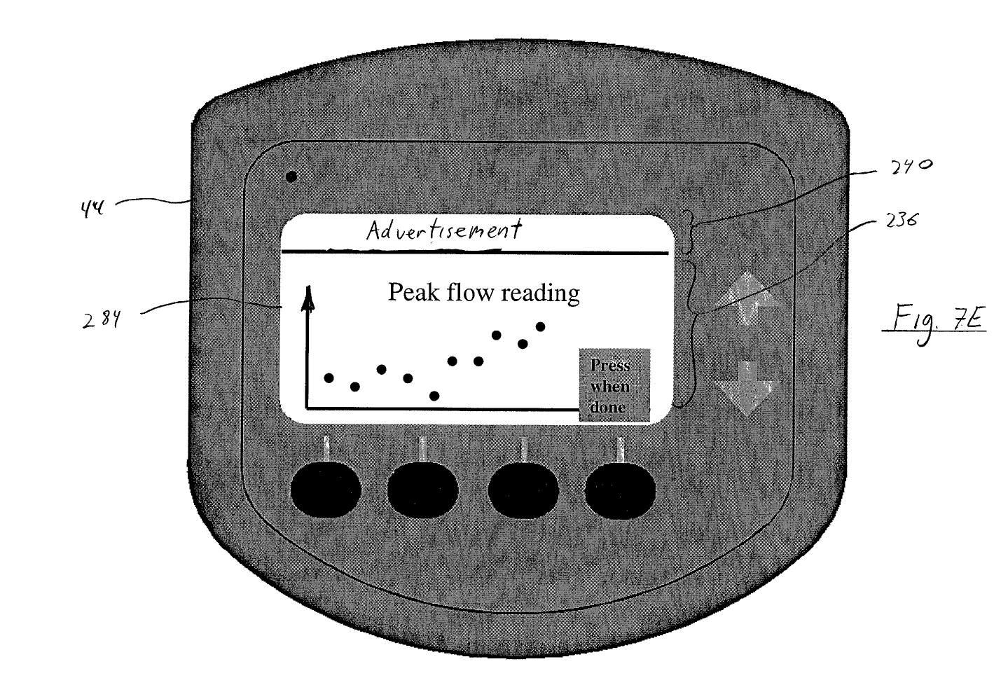

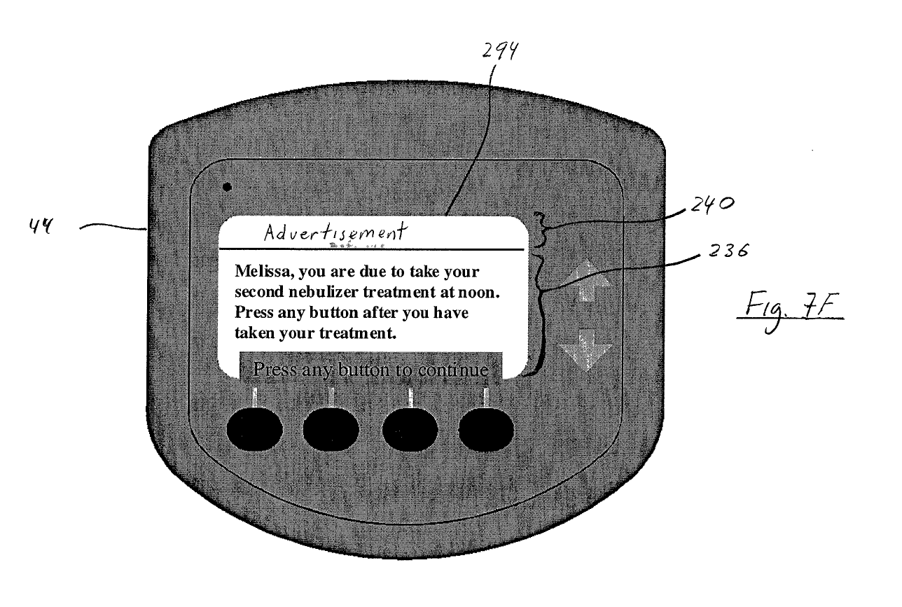

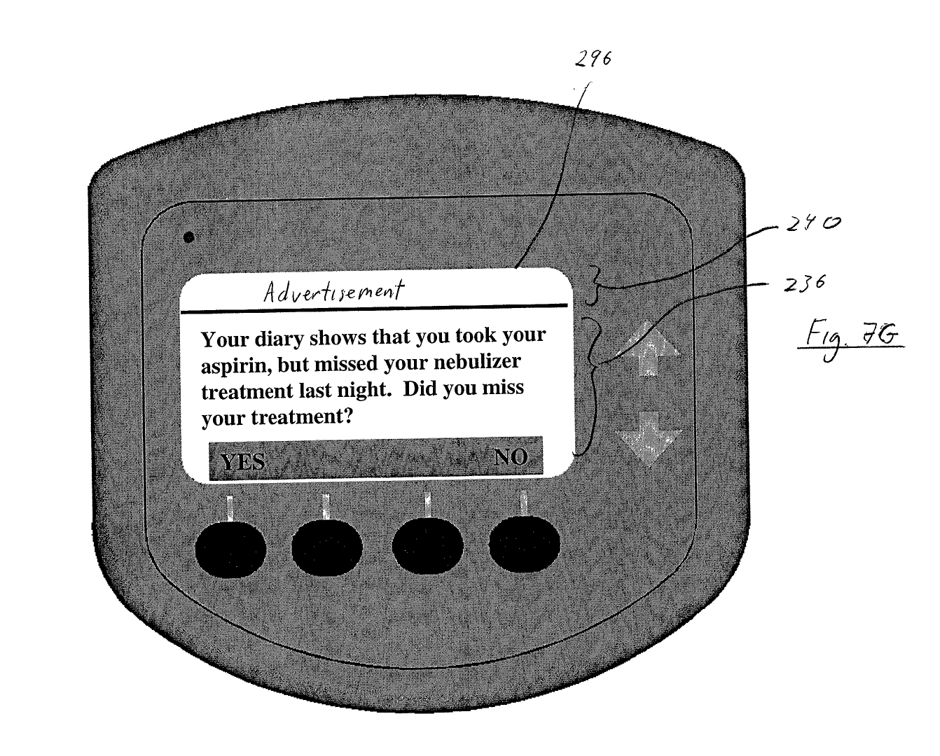

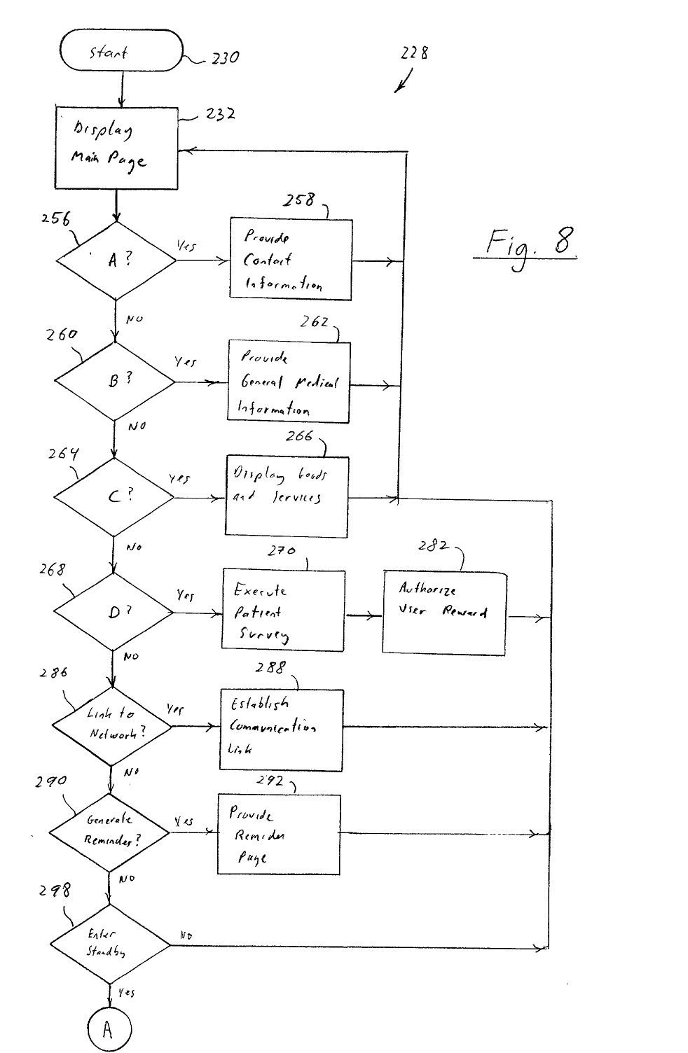

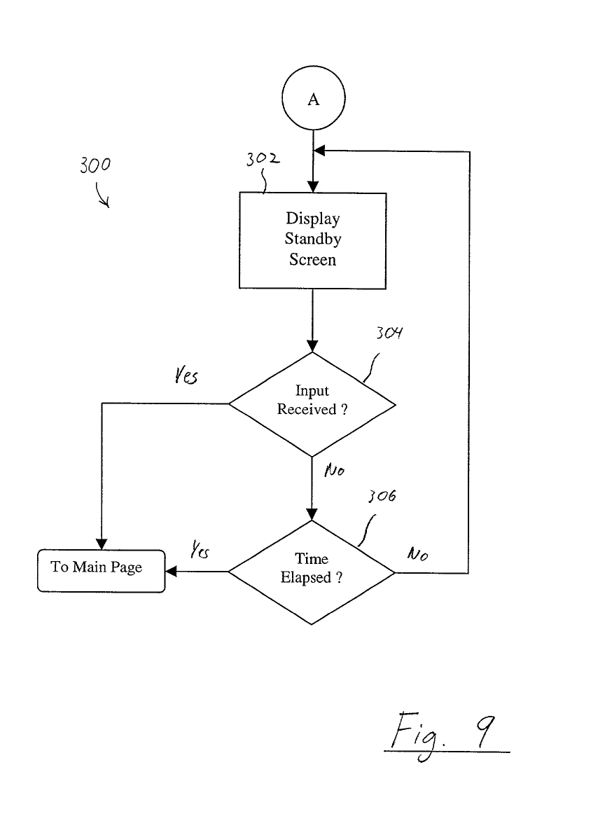

One embodiment of the present invention contemplates that patient interface appliance 44 is a relatively inexpensive piece of hardware that runs a patient interactive routine and accesses the communication network, as well as communicates with other medical equipment, if desired, so that it is easy to use by patients with little or no computer experience. The present invention further contemplates that patient interface appliance 44 includes additional input/output devices, e.g., LED 224 in FIG. 7A, for indicating that the unit is in an active mode or a stand-by mode, or that the battery is low. The patient interface appliance can also include other features commonly used to provide information to the user, such as a speaker, bell or buzzer to sound alerts and provide audio information to a user.

The present invention also contemplates optionally providing patient interface appliance 44 with other input/output terminals to allow the appliance to communicate with conventional computer-related peripheral devices, such as a printer, additional memory modules, speakers, microphones, external displays, and specialized input devices, such as a track ball, pen and pad pointer, and joystick.

In the embodiment described above, patient interface appliance 44 is a limited-use device in that its most basic operation is to run a preprogrammed routine for displaying a survey or series of questions to the patient, the answer or answers to which are collected and provided to server 34. The present invention contemplates, however, that a patient can use an appropriately configured computer terminal in place of appliance 44 to provide additional capabilities to the user, such as the ability to run conventional computer programs and access the internet in real time. When using a computer terminal in place of patient interface appliance 44, it may be necessary to employ an adapter or other device that allows the conventional computer terminal to communicate with medical devices or systems 54.

The present invention further contemplates that patient interface appliance 44, may, itself be a medical device capable of administering a medical treatment, monitoring a medical condition, or both. For example, the present invention contemplates that the functions of the patient interface appliance can be incorporated into a pressure support device, such as a continuous positive airway pressure (CPAP) device, bi-level pressure support device, auto-titration device, or ventilator, so that the patient interface device also functions as a medical device for administering a pressure support or ventilation therapy to a patient. FIG. 4 illustrates the patient interface appliance having the additional features of a pressure support system.

As shown in FIG. 4, a pressure generator 59, which preferably operates under the control of processor 47, generates a flow of breathing gas, as indicated by arrow A, for delivery to an airway of patient. With an appropriate pressure controller 61, such as a pressure control valve, and/or through controlling the operating speed of pressure generator 59, the patient interface appliance provides variable pressure levels to the patient, either during each respiratory cycle, as done by a ventilator or bi-level pressure support system, or over periods of time, as done by an auto-titration pressure support system or by a CPAP device with a selectable pressure level or a pressure level that can vary in some manner, such as a ramp pressure, which allows the patient to receive a low pressure while trying to fall asleep an gradually increases.

To achieve these more complicated forms of pressure/flow control, the present invention contemplates providing a flow sensor 63 and/or pressure sensor 65, for monitoring the flow and/or pressure of breathing gas delivered to the patient. This is necessary, for example, in a bi-level or ventilator system operating on a spontaneously breathing patient, to determine when the appropriate cycle and trigger points occur. To achieve that auto-titration pressure support, where the pressure level varies with the condition of the patient, for example by increasing the pressure levels if the patient experiences snoring, apneas, or obstructed breathing, the present invention contemplates providing other sensors, such as a microphone, respiratory belt, and oximeter, either alone or in combination with flow and/or pressure sensors 63 and 65, for monitoring the condition of the patient and controlling the pressure support based thereon.

Examples of a bi-level pressure support system and the techniques for distinguishing between inspiration and expiration in an a single-limb patient circuit are disclosed in U.S. Pat. Nos. 5,148,802; 5,313,937; 5,433,193; 5,632,269; 5,803,065; and 6,029,664, the contents of which are incorporated herein by reference. Examples of an auto-titration system pressure support system are disclosed in U.S. Pat. Nos. 5,203,343; 5,458,137, and 6,085,747 all to Axe et al. and U.S. Pat. No. 5,645,053, the contents of which are incorporated herein by reference.

In addition, to these modes of pressure support, the present invention contemplates that the patient interface appliance can provide other conventional modes of pressure support, such as proportional assist ventilation (PAV®) and proportional positive airway pressure (PPAP) ventilation. PAV is taught by U.S. Pat. Nos. 5,044,362 and 5,107,830 both to Younes et al., the contents of which are incorporated herein by reference. PPAP ventilation is taught by U.S. Pat. Nos. 5,535,738; 5,794,615, and 6,105,575 all to Estes et al., the contents of which are incorporated herein by reference.

In the embodiment of FIG. 3, an authorized third party 40 interacts with server 34 via third communication link 42 using a conventional computer terminal 58, which can be a stand-alone system or a terminal in a larger LAN or WAN system. The physical connection between computer terminal 58 and server 34 can be accomplished in the same manner appliance 44 interacts with server 34, namely through communication network 46, which, as noted above, is preferably the internet. Once third communication link 42 between computer terminal 58 and server 34 is established, server 34 controls the presentation or exchange of information during this log-on session so that the third party interacting with the information management center is provided with a third party tailored presentation 60.

Computer terminal 58 includes a display 62 and at least one input device 64, such as a keyboard and mouse, so that the computer terminal can be used to interact with information management center 32. Computer terminal 58 functions as any conventional internet access platform to access communication network 46. Of course, computer terminal 58 can operate in conjunction with conventional computer-related peripheral devices, such as a printer, additional memory modules, speakers, microphones, and specialized input devices, such as a track ball, pen and pad pointer, and joystick.

It should be noted that FIG. 3 does not illustrate the manner in which a healthcare professional or a database administrator accesses information management center 32. This is so, because the present invention contemplates that a healthcare professional or administrator interacts or accesses information management center 32 using substantially the same physical components as used by third party 40, i.e., a computer terminal configured to access server 34 via a communication network. Thus, the network configuration by which a healthcare professional accesses information management center 32 is the same as shown in FIG. 3 for third party 40. However, a healthcare professional tailored presentation is presented to the healthcare professional, which is different from the third party tailored presentation.

Although the communication links between information management center 32 and patients 12, healthcare professionals 16, and third parties 40 are described above as being provided in an internet based network, the present invention contemplates that first communication link 36, second communication link 38, and the third communication link 42 can be the communication link used in any conventional communication network, such as a telephone based communication link, a LAN communication link, and a WAN communication link, or any combination thereof.

In the illustrated exemplary embodiment, server 34 in information management center 32 includes a memory 66 and a microprocessor 68. Memory 66 is any information storage device, such as a hard drive, RAM, or ROM, that is capable of storing information, such as patient biographical information, patient medical information, general medical information, and any other information or data that may be of interest to any party interacting with the information management center. Memory 66 can also contain algorithms for processing the data stored therein, operating microprocessor 68, communicating with other servers, or performing any other tasks commonly preformed by a microprocessor platform.

A patient's biographical information includes, for example, the patient's name, age, address, phone number, emergency phone number, date of birth, marital status, social security number, guardian name, address, and phone number, primary care physician name, address, and phone number, health insurance provider name, address, and phone number, e-mail address. The patient's medical information includes any information pertaining to the patient's health, such as past medical history, current medical information, e.g., current disease states, diagnoses, physiological parameters or conditions currently being monitored, the results or information gathered from this monitoring, and information regarding the patient's ongoing medical treatments, the treatment plan, prescription, or any combination thereof.

This patient biographical and medical information can be provided to information management center 32 in a variety of ways. For example, it can provided by the patient or it can be provided through the first communication link from a monitoring device being used by the patient. The patient information can also be provided by the healthcare professional via the second communication link. Patient biographical and medical information can be also input at the information management center using information provided by either of from any source. Typically, the patient's biographical information and past medical history are provided by the patient or the healthcare professional to the information management center at the time the patient's account or file is created in management center 32. This can be done electronically or otherwise.

Processor 68 is any conventional processor capable of executing an algorithm, which may be downloaded from a processor memory (not shown), such as a conventional ROM or RAM or from memory 66. A data bus 70 or other suitable communication line allows processor 68 to communicate with memory 66 and other internal or external devices. The present invention contemplates that server 34 communicates with other servers, if necessary, via conventional communication techniques. For example, the present invention contemplates that the bulk of the patient biographical information and medical information is contained in a small number of servers, which are accessed from other remote servers when a patient, healthcare professional, or third party, accesses the information management system via the remote server. The present invention further contemplates that server 34 is configured to communicate with one or more external devices 72, such as a computer terminal at the server site, a printer, satellite communication link, or any other input/output device.

Memory 66 and processor 68 cooperate to receive information provided by a patient via the first communication link, by a healthcare professional via the second communication link, and by a third party via the third communication link, and to process this information. This information can then be used to manage the medical condition of the patient. For example, one embodiment of the present invention contemplates that processor 68 review the information received via the first communication link and automatically provide a notification to the patient, healthcare professional, or third party if the information is outside established parameters. The present invention also contemplates providing an alarm or reminder to any of these users if the patient fails to provide the expected information. In addition, the information management center can be used to prepare a summary of the medical information that its managing and provided this summary to any authorized user. For example, the summary may report on the number of times the patient failed to use their CPAP device or take their medication in the past month.

There may be situations where the patient, the healthcare professional, or the third party, may not have access to an internet accessible device or a computer terminal to accessing the information management system. Also, many people are uncomfortable or incapable of using a computer terminal or similar device. For example, third party family member, while traveling without access to an internet compatible computer, may still want to check whether their grandmother took her medication. For this situation, the present invention contemplates providing information management center 32 with a voice synthesizing program so that the same general information available to the user via the computer can be provided orally via the telephone using this program.

The present invention also contemplates that the party accessing the information management system can request or be prompted to identify the communication medium by which the information is communicated. For example, a third party calling the information management system via telephone, which is one type of communication medium, may be prompted by a computer controlled menu program run on the server to indicate whether the information they are requesting should be provided using the same medium, i.e., via voice synthesization, or using a different medium, such as via e-mail to an existing or new e-mail address, or via facsimile to an existing or new fax number. The substance and presentation format should be the same regardless of the medium used to communicate the information to the accessing party. A similar medium designating capability can be provided to parties accessing the information management system via a computer terminal so that the requested information can be displayed or presented orally at that time on-line, sent to an e-mail number, or sent facsimile. Because the entire exchange between the accessing third party and the information management system is controlled by the processor in the server, this high degree of flexibility in the communication medium is possible.

Of concern with any medical information management system is the confidentiality of the information contained in that system. To this end, the present invention contemplates assigning a unique identification number to each patient subscribing to the medical information management system. Information management center 32 contains a patient information access table identifying the users (patients, healthcare professionals, and third parties) who are authorized to access the information for each identification number, i.e., for each patient. To access the system, each user must preferably provide a username and password, with the information management center 32 containing a list of all authorized users and their passwords. Of course, conventional security techniques, such as data encryption and firewalls, are contemplated by the present invention in maintaining system security and integrity.

Accessing the information management center 32 can be done through a standard internet compatible device, such as computer terminal 58, or through a dedicated appliance, such as through patient interface appliance 44. If a standard internet compatible device is used, the accessing entity provides his or her username and password. The system allows the user to access confidential patient information only if the username and password are authenticated. If a dedicated patient interface appliance is used, the present invention contemplates that the accessing entity need not provide his or her username and password, but would be given automatic access to the information management system.

This automatic access is appropriate because patient interface appliances 44 would only be provided to those patients subscribing to medical information management system 30 and use or access to the patient interface appliances would be limited strictly to such patients. Of course, if desired, the information management system can be configured to require patients using patient interface appliances to also input usernames and passwords. This can be done at the time the device is assigned to the patient, with the device providing this information each time it synchronizes with the server, or the username and password can be required each time first communication link 36 to the server is to be established.

Once a valid user is established, the system determines which, if any, patient files can be accessed by that user by referring to the patient information access table. For example, it is expected that a healthcare professional will be given access to all patients under his or her supervision. A patient, however, is only given access to his or her file. Similarly, a third party is only given access to the patient files where authorization or consent to access has been given. Of course, a third party may be entitled to access more than one patient file if more than one patient has given authorization to that third party. For example, a son may be given access to the medical information of both parents and each grandparent.

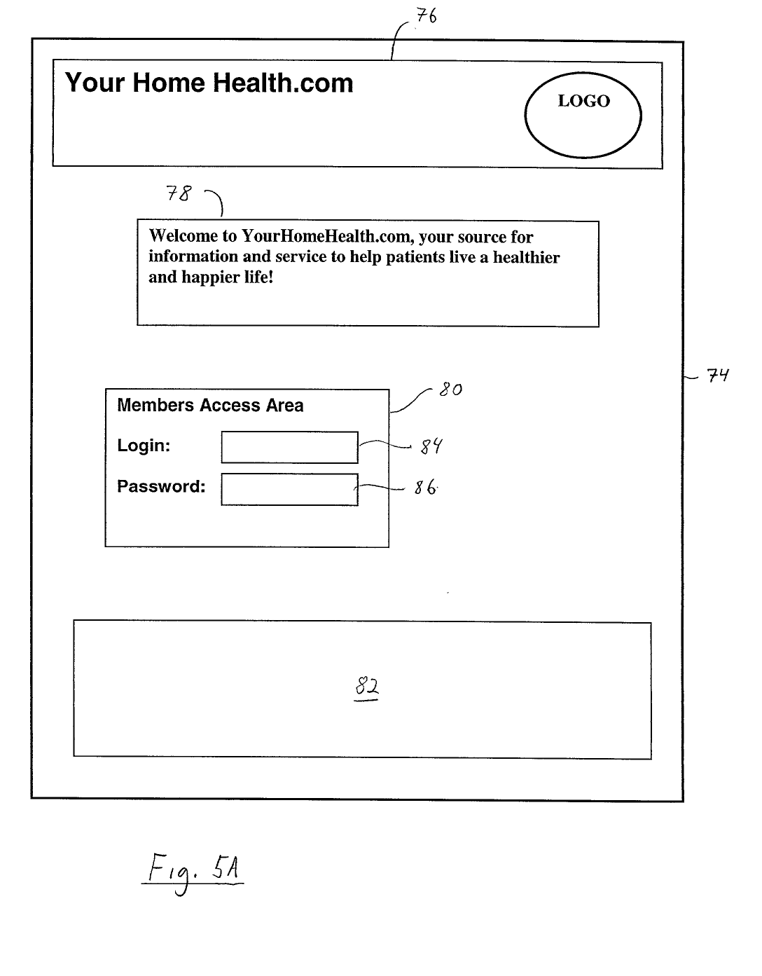

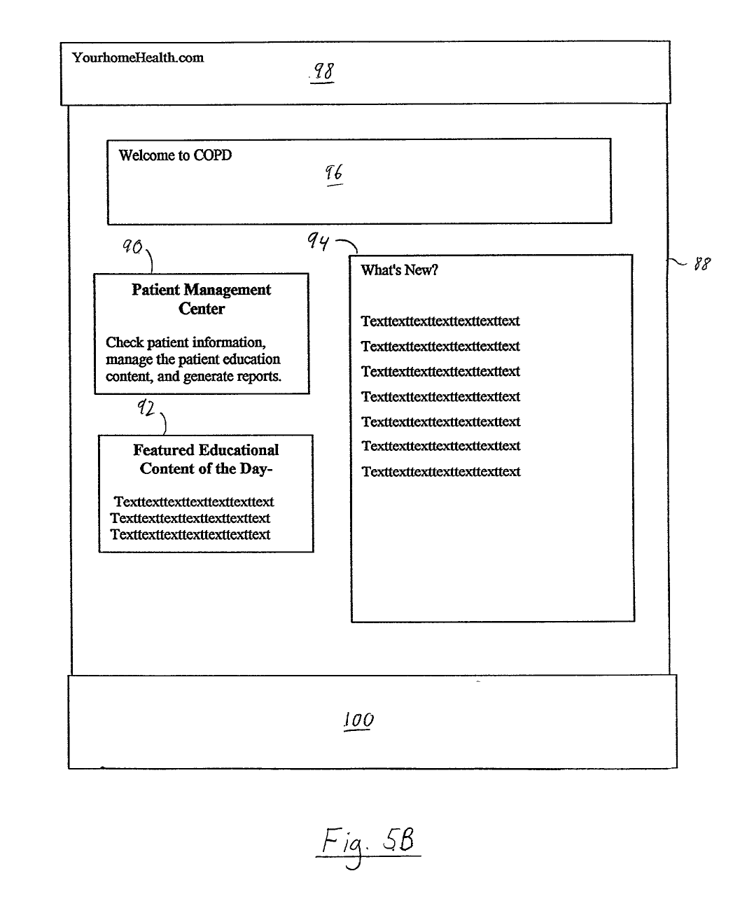

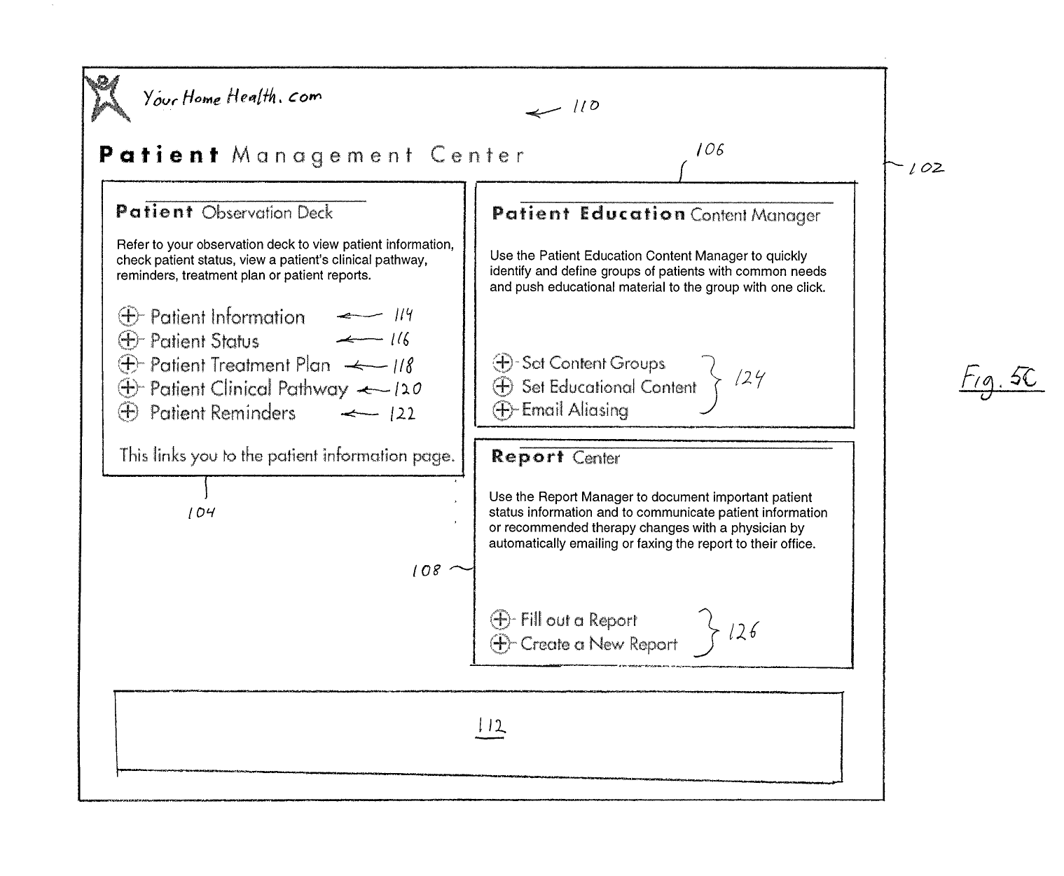

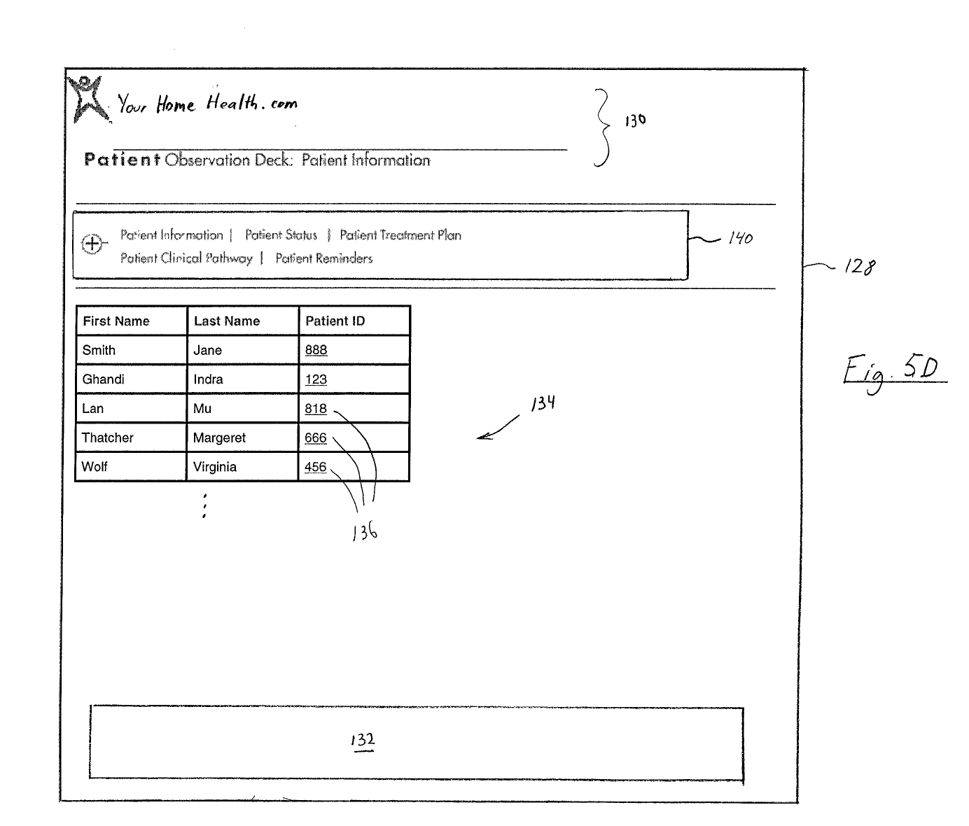

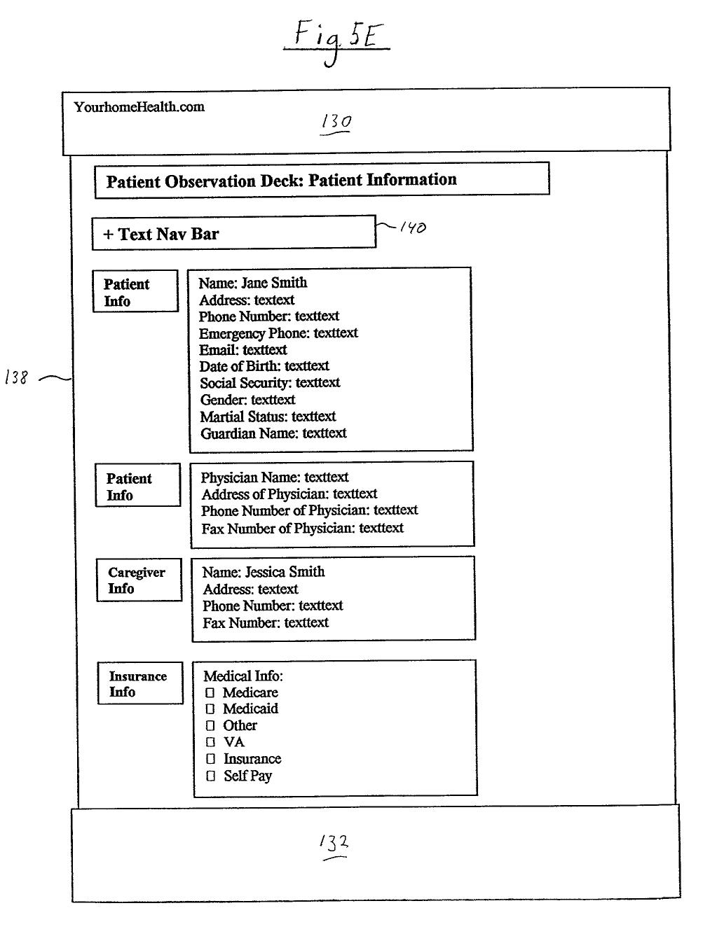

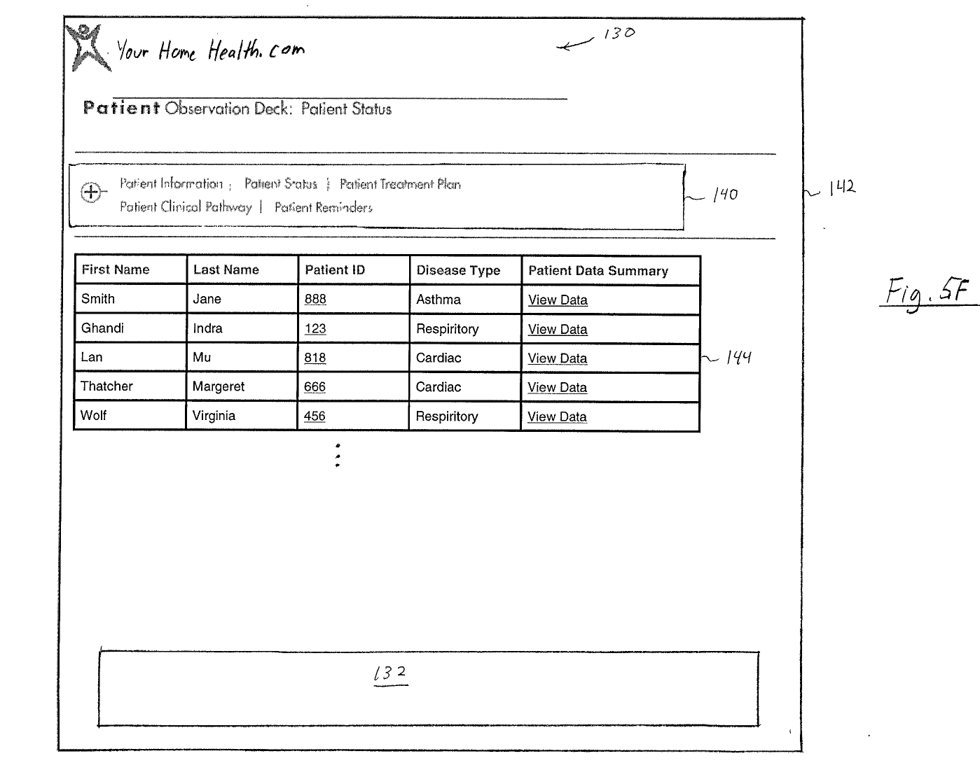

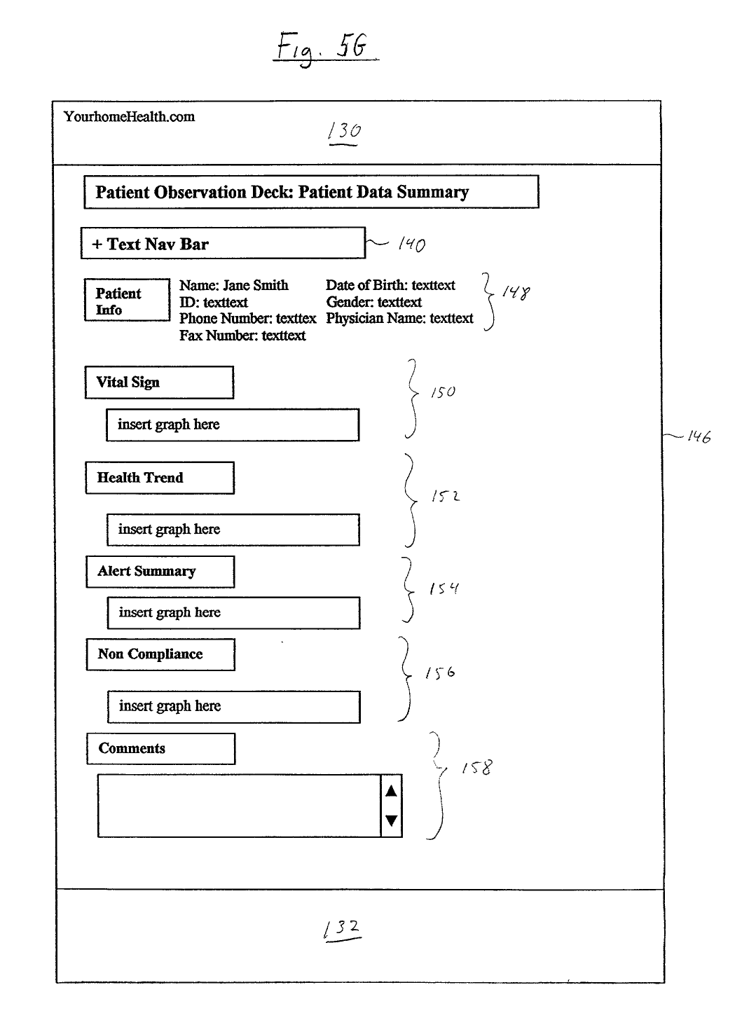

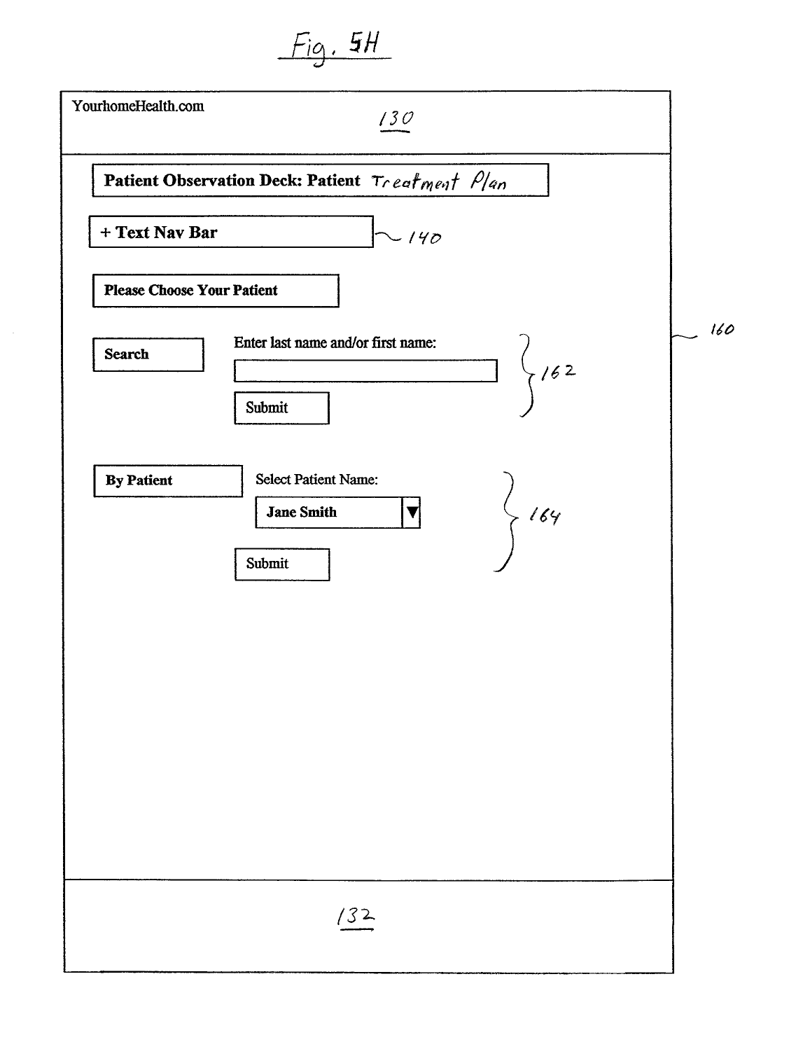

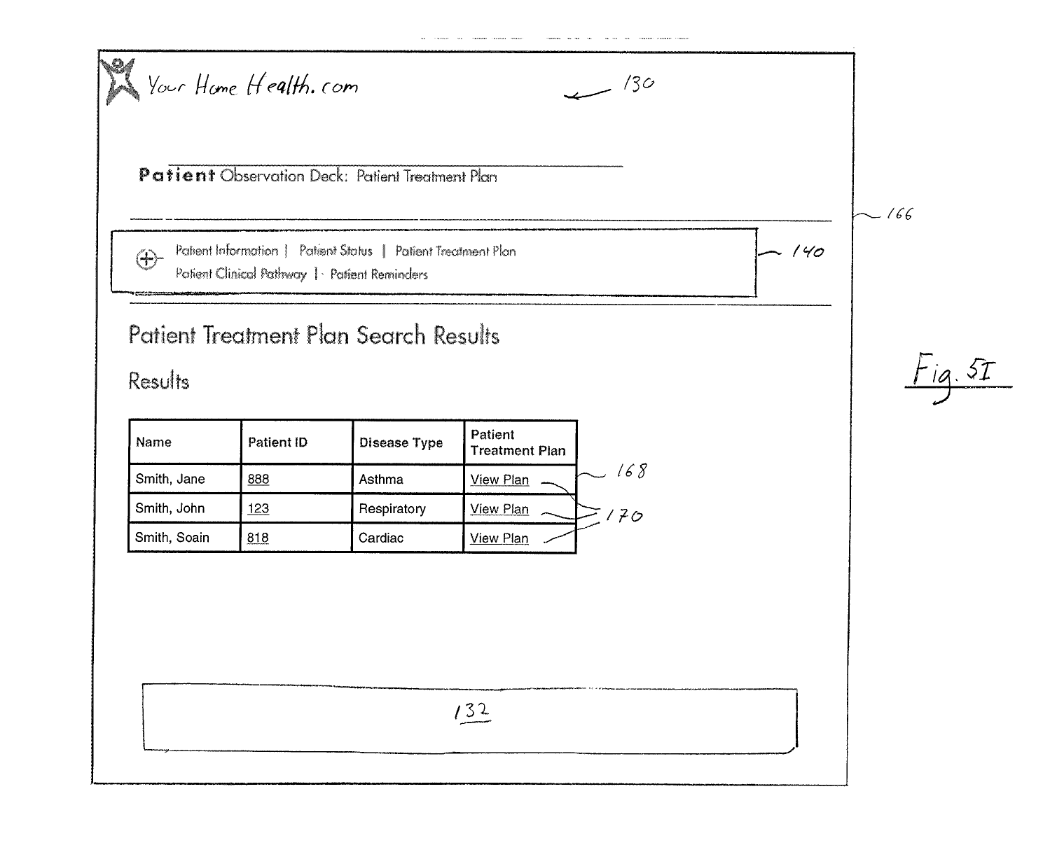

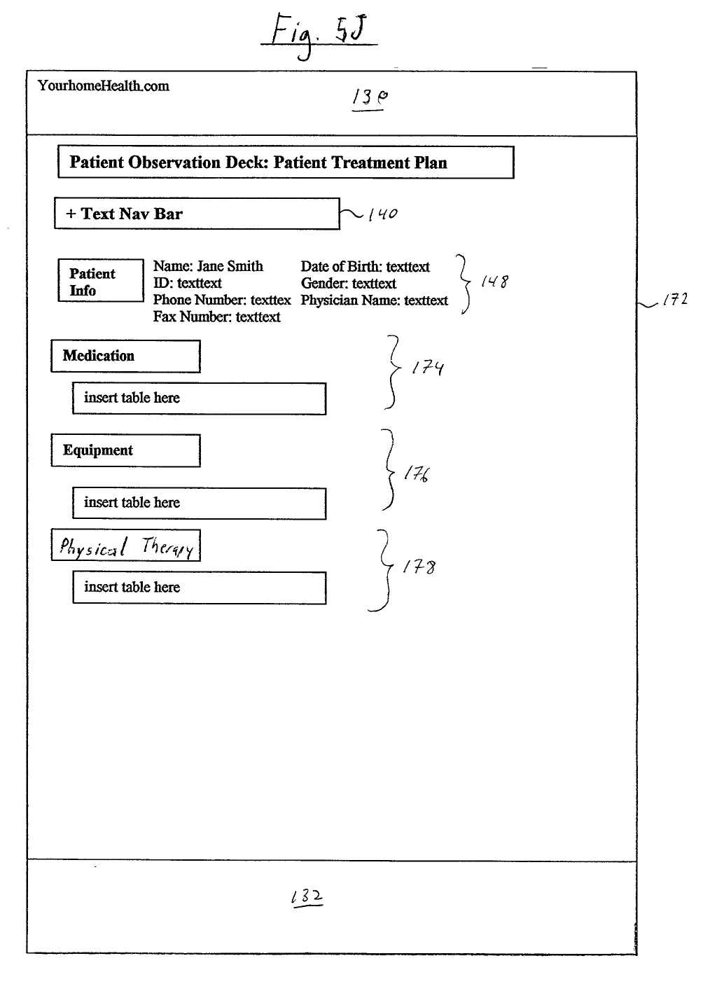

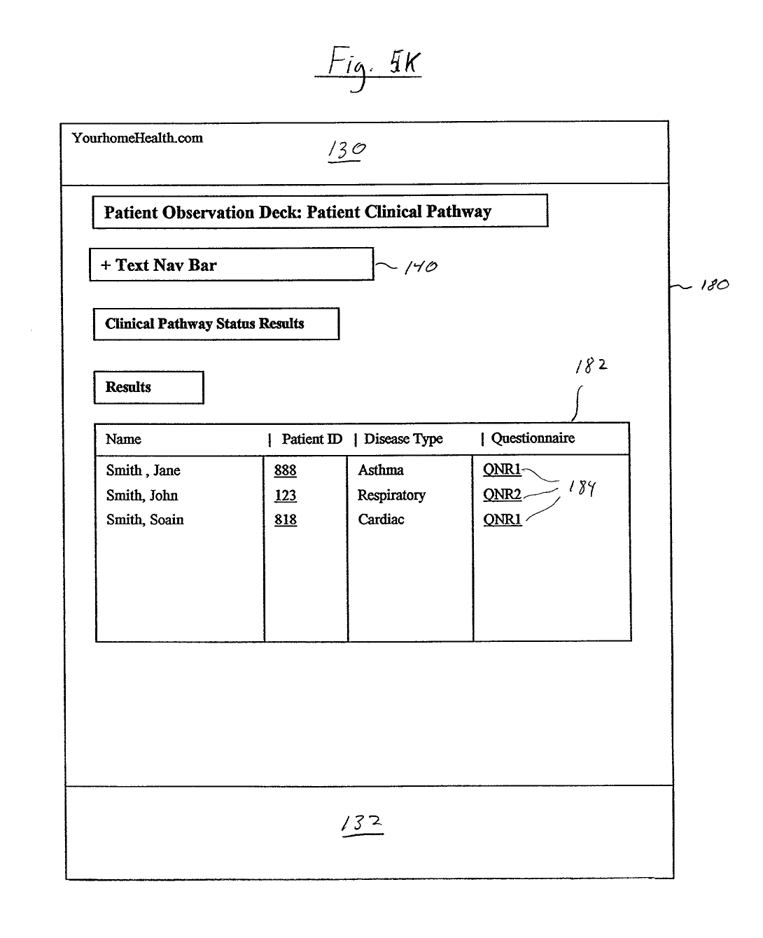

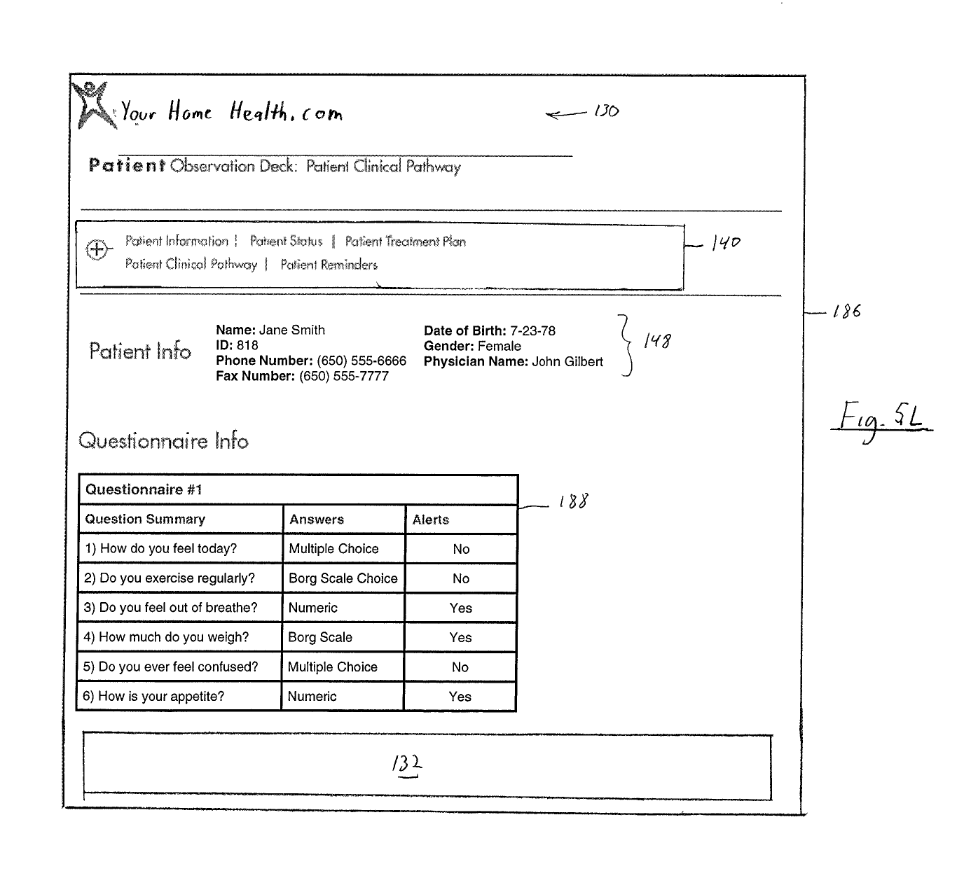

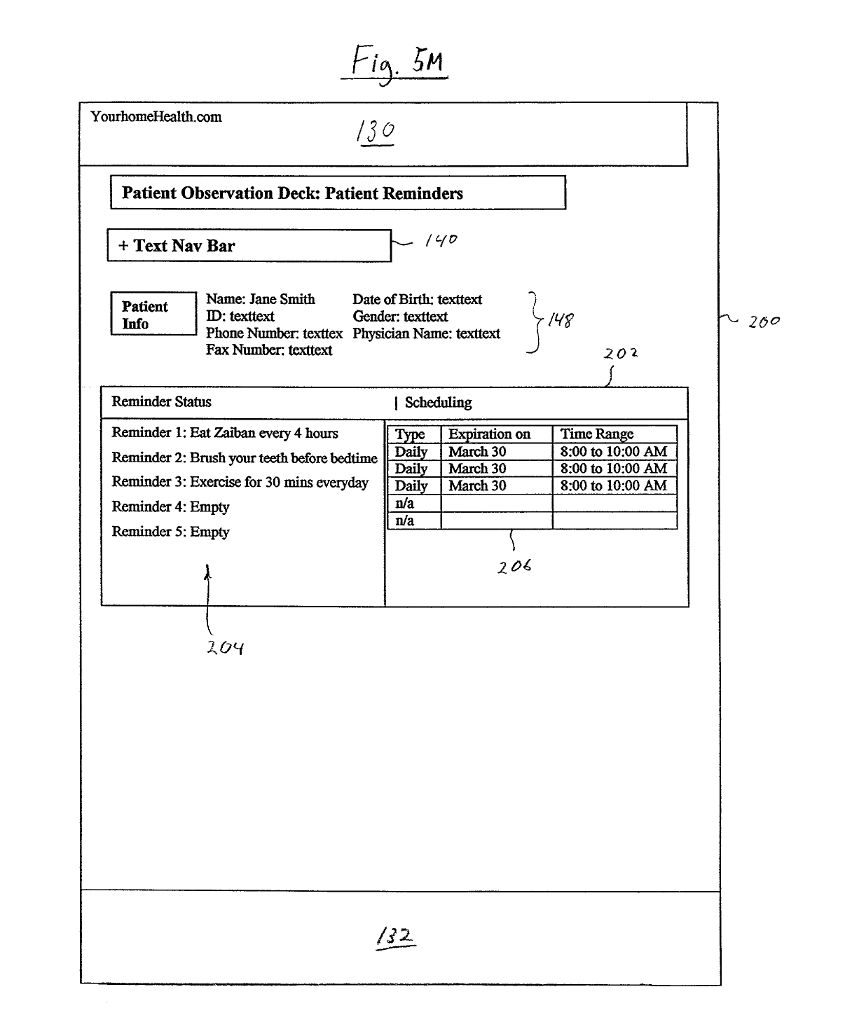

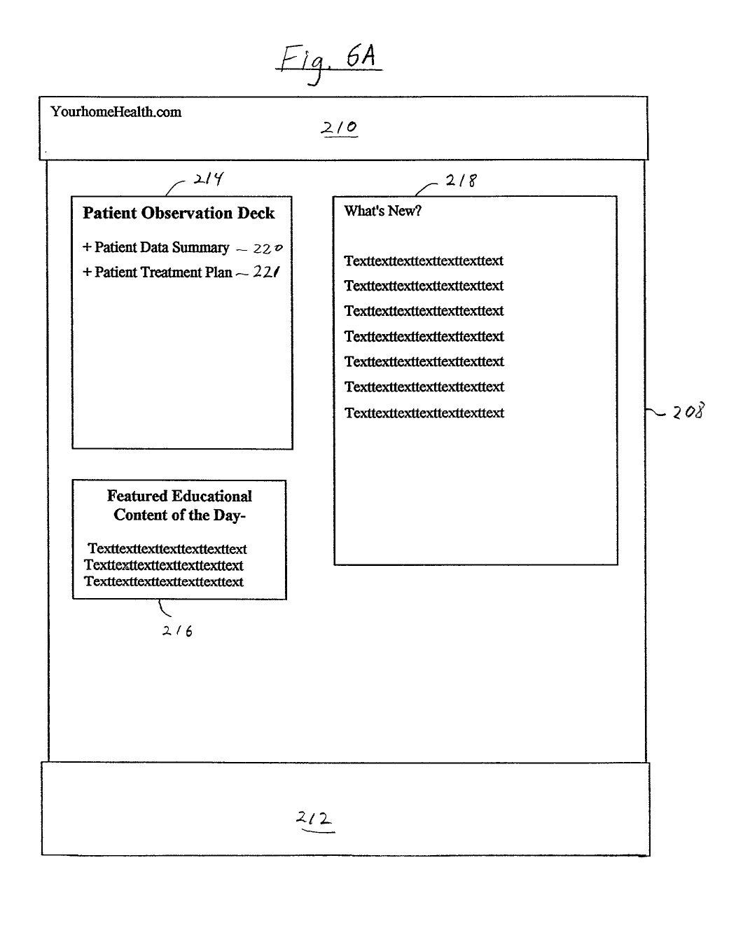

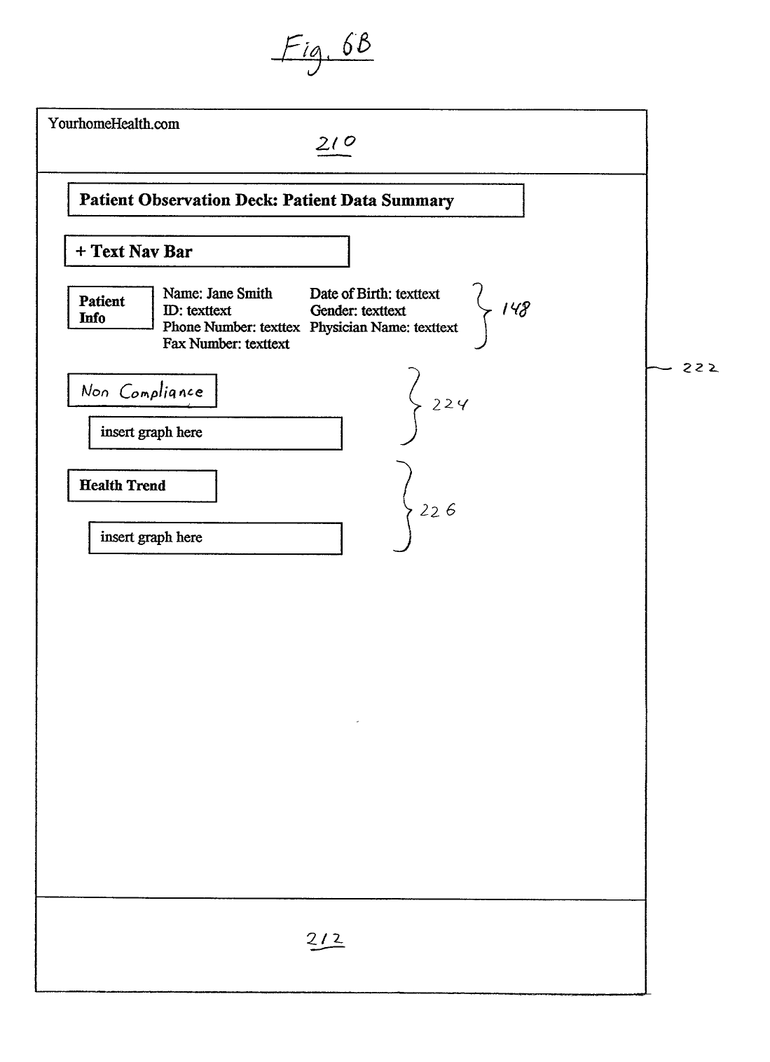

As noted above, the format or procedure for presenting information between a user and medical information center 32 is dependent upon the type or category of user, i.e., healthcare professional, third party, or patient, accessing the medical information center. FIGS. 5A-5M illustrate an example of a display presentation tailored for use when a healthcare provider interacts with the medical information management system. FIGS. 6A-6B illustrate an example of a display presentation tailored for use when an authorized third party interacts with the medical information management system. In addition, FIGS. 7A-7G illustrate a display presentation provided on patient appliance 44 that is tailored for use when a patient indirectly (not in real-time) interacts the medical information management system via the patient appliance.

Each figure in FIGS. 5A-5M represents the image shown, for example, on one web page in the healthcare professional tailored presentation. FIG. 5A illustrates a start page 74 presented to the healthcare professional. Start page 74 includes a header field 76, a text field 78, a login field 80, and an advertisement field 82. In an exemplary embodiment of the present invention, header field 76 contains information such as a company name, company logos, trademarks or service marks, and other titles or general web links. Text field 78 preferably contains information explaining the start page. Login field 80 includes sub-fields 84 and 86 in which a subscriber to the information management system enters his or her username “login” and password to gain access to the patient medical information. Advertisement field 82 is available for advertisements as a means for generating revenue for the company managing the medical information management system, and, in particular, for subsidizing the costs of maintaining the medical information management system.

Although only subscribers to the medical information management system can gain access to the confidential patient information, the present invention contemplates that the information management system also contains general medical information, such as information regarding specific diseases and treatments, latest medical news, etc. Access to this information can be provided to members and non-member alike. In which case, start page 74 preferably includes a medical education field (not shown) with one or more links to additional pages containing such information. Of course, start page 74 can include other links and information, such as links to an e-commerce page and links to related medical web sites.

FIG. 5B illustrates a healthcare professional main page 88 that is presented to a healthcare professional authorized to access the medical information management system via page 74. Main page 88 includes a patient management center active field 90 and, other optional fields, such as educational information field 92 and a “latest news” field 94, one or both of which can also be an active field. For purposes of the present invention, an “active field” is at least a portion of a display that contains a link that, when actuated, cause an additional page or pages to be displayed. Main page 88 also contains a text field 96, a header field 98, and an advertisement field 100, either of which can also be an active field that, when activated, cause other linked items or pages to be displayed.

Activating patient management center active field 90 or an active link in that field causes a patient management center page 102 to be displayed, which is used to review the medical or biographical information for each patient being supervised by that healthcare professional, as discussed below with respect to FIG. 5C. In the exemplary embodiment of the present invention, educational information field 92 is an active field, which, when activated causes educational material to be displayed. Such educational material may include, for example, tutorials on the diagnosis and treatment of various disease states. Latest news field 94 preferably provides information on the latest medical developments, such as the latest medications and treatment techniques. It is to be understood that general medical information and latest new fields 92 and 94 are optional and they may or may not contain active links to additional web pages. It is to be further understood that the arrangement, i.e., the size, location, format, placement, position, and shape of the fields in main page 88 is not intended to be limited that the specific example shown in FIG. 5B.

FIG. 5C illustrates a patient management center page 102 that is accessed via patient management center active field 90 in page 88 of FIG. 5B. Patient management center page 102 serves as a launch point for allowing a healthcare professional to select and review the medical information on each patient that subscribes to the information management system and that is under the supervision of that subscribing healthcare professional. Patient management center page 102 also allows the healthcare professional to provide information to his or her patients and monitor or alter patient's treatment, as discussed in detail below.

In the exemplary embodiment illustrated in FIG. 5C, patient management center page 102 includes a patient observation field 104, a patient education content manager field 106, and a report center field 108. Page 102 also includes a header field 110 and an advertisement field 112. Patient observation field 104 includes a patient information link 114 (discussed below with reference to FIGS. 5D and 5E), a patient status link 116 (discussed below with reference to FIGS. 5F and 5G), a patient treatment plan link 118 (discussed below with reference to FIGS. 5H, 5I and 5J), a patient clinical pathway link 120 (discussed below with reference to FIGS. 5K and 5L), and a patient reminder link 122 (discussed below with reference to FIG. 5M).

Patient education content manager field 106 includes links 124 that allow the healthcare professional to quickly identify and define groups of patients with common needs and distribute educational material to those groups. For example, the healthcare professional may be supervising a group of patients suffering from OSA. The patient education content manager field 106 allows the healthcare professional to identify these patients as a group and distribute information on, for example, the latest CPAP devices and mask interfaces to these patients, preferably via e-mail. Links 124 are used to define the groups, the content of the material to be distributed the various groups, and the e-mail address for the patients in the defined groups.

Report center field 108 includes links 126 that allow the healthcare professional to document important patient status information and to communicate patient information or recommended therapy changes with other healthcare professionals in the form of reports. Such reports, once generated, are preferably sent to the receiving party via e-mail or via facsimile automatically. Links 126 are used, for example, to prepare the report and create new reports. For example, a specialist may prepare a report to the patient's primary care physician of HMO recommending that the patient receive a certain medical procedure, begin a particular medical treatment, or modify an existing treatment. The report preferably includes e-mail address information so that information management center 32 can automatically identify the recipient and sent the report to the receiving party.

FIG. 5D illustrates a patient information page 128 that is displayed when the healthcare professional actuates patient information link 114 in patient observation field 104 of patient management center page 102. Patient observation page 128 includes a header field 130, an advertisement field 132, and a patient listing field 134, which lists all of the patients associated with that healthcare professional contained in the medical information management system. This patient listing includes the name and a patient identification number 136 for each patient. The patient ID also serves as an active link to a detailed individual patient information page 138 that contains biographical information on each patient. Patient observation deck page 128 also contains a navigation bar 140 that provides active links to other pages in the healthcare professional tailored presentation. In an exemplary embodiment of the present invention, the links in navigation bar 140 are the same as links 114-122 provided in patient observation field 104.

An example of patient information page 138 is shown in FIG. 5E. Patient information page 138 includes biographical information such as the patient's name, address, social security no., date of birth, phone and fax number, and e-mail address. It also includes information on the patient's physician, third party or parties authorized to access the medical information of that patient, and insurance information. This list of information, including that shown in FIG. 5E, is not intended to be exclusive or exhaustive, because it can be readily appreciated that any patient biographical information can be contained in patient information page 138.

FIG. 5F illustrates a patient status page 142 that is displayed when the healthcare professional actuates patient status link 116 in patient observation field 104 of patient management center page 102. Patient status page 142 includes a listing 144 of all of the patients associated with that healthcare professional that are contained in the medical information management system. A “view data” link 145 is provided for each patient included in listing 144. Actuating view data link 145 provides access to the medical information for that patient in the form of a medical data summary page 146 shown in FIG. 5G.

The illustrated exemplary embodiment of medical data summary page 146 includes a patient information area 148 identifying the patient and a number of areas containing medical information. For example, a vital signs area 150 displays physiological information, which is any information pertaining to the health or medical condition of the patient, such as oxygen saturation, peak flow results, or patient answers to questions regarding his or her health. This information is collected from the patient or from a medical monitoring device used by the patient, such as a spirometer. The present invention contemplates displaying this information in vital signs area graphically. It is to be understood, however, that this information can be displayed as a data chart, as raw data, or in any manner suitable for use by the healthcare professional. The present invention further contemplates that the format for displaying such data in this page can be selected by the user so that he or she is presented with the information in the manner they prefer.

Other information display areas in medical data summary page 146 include a health trend area 152 that displays a trend analysis of the physiological data collected from the patient. This area can indicate, for example, that the patient's weight is increasing, their peak expiratory flow is decreasing, and so on. An alert summary area 154 notifies the healthcare provider if the information or data collected from the patient or from other sources is outside established thresholds.

For example, if the patient's peak flow reading falls below a certain level an alert is posed in alert summary area 154. Preferably, the alert would include details about the time the alert occurred and the nature of the alert. A non-compliance area 156 provides information regarding the patient's use (or non-use) of a prescribed or recommended medical treatment. For example, if patient fails to report that they took their prescribed medication or took the medication late, this failure or delay can be posted in non-compliance area 156. In a more sophisticated example, the medical device that the patient has been prescribed, such as a CPAP device, has the ability to monitor the patient's use of the device and report such use directly to the medical information management system without any patient interaction. The compliance data gathered from the device can be displayed in area 156. Finally, a comments area 158 provides a location where the healthcare professional can review comments from external sources, such as the patient or the third party caregiver associated with that patient.

FIG. 5H illustrates a patient select page 160 that is displayed when the healthcare professional actuates patient treatment plan link 118, patient clinical pathway link 120 or patient reminders link 122 in patient observation field 104 of patient management center page 102. The purpose of patient select page 160 is to allow the healthcare professional to select the particular patient whose treatment plan, clinical pathway, or reminders are to be reviewed. In the illustrated exemplary embodiment of the present invention, selecting the patient is accomplished by searching for the patient using patient search terms, such as the patient's name, provided in search field 162 or by selecting the patient from a list of all patients provided in patient name select field 164. Of course, the patient select page can include only search field 162 or patient name select field 164.

FIG. 51 illustrates a patient treatment plan search results page 166, which displays the results of a search conducted using search field 162 in patient select page 160. For example, if the name “Smith” is searched, all of the patients associated with that healthcare professional whose last name is “Smith” are displayed in patient listing field 168 along with a “view plan” link 170 for each patient. The healthcare professional can then select the treatment plan to be displayed by actuating the view plan link for a patient. Of course, if the patient is directly selected using patient name search field 164, patient treatment plan search results page 166 need not be displayed, and the patient treatment plan for that patient is displayed directly.

FIG. 5J illustrates a patient treatment plan page 172 for displaying the medical treatment being administered to a patient. In the illustrated exemplary embodiment, patient treatment plan page 172 includes the therapies being administered to the patient as well as the physiological monitoring being performed on the patient. In FIG. 5J, the therapies administered to the patient include a medication area 174 listing the medication, dosages, quantity, refills, and any other information relevant to the medication that is prescribed to the patient. If the patient is using any medical devices, such as a CPAP device, ventilator, phototherapy equipment, or oxygen concentrator, this equipment is listed in equipment area 176, along with the prescribed usage, settings for the device, and any other information relevant to the medical equipment.

If the patient is undergoing physical therapy, the type of therapy, and details about the therapy, such as the weights to be use and the number or repetitions to be performed, are displayed in physical therapy area 178. Although not shown, the present invention also contemplates providing additional areas that describe any monitoring devices being used by the patient, the parameters being monitored, and any other information relevant to such monitoring. It is to be understood that other information areas can be provided so that any information regarding the medically related treatments being used by the patient can be captured and displayed to the healthcare professional.

FIG. 5K illustrates a patient clinical pathway search results page 180 that is displayed when the healthcare professional actuates patient clinical pathway link 120 in patient observation field 104 of patient management center page 102 and selects a particular patient using patient select page 160. Patient clinical pathway search results page 180, like patient treatment plan search results page 166, displays a listing 182 of the patient or patients selected using patient search field 162 in patient select page 160. A questionnaire link 184 is associated with each patient. Listing 182 also optionally includes a brief identification of the each patient's disease type, if any. Actuating questionnaire link 184 displays a patient clinical pathway page 186 that includes a listing 188 of the questions to be presented to the patient during an interactive session. See FIG. 5L. Of course, patient clinical pathway page 180 and can be avoided and direct access provided to patient clinical pathway page 186 if the patient is selected directly using patient name select field 164 in patient select page 160.

Patient clinical pathway page 186 in FIG. 5L is used to show the healthcare professional the questions being presented to the patient during an interactive session. The present invention contemplates that periodically or as needed, the patient will be directed to answer one or more questions regarding their medical condition, treatment, or monitoring procedures. Such information may be helpful, for example, in accessing the effectiveness of the current treatment plan and in identifying other potential areas of concern. These questions may be similar the questions a physician asks a patient with a certain disease type during an office visit.

The present invention contemplates that the questions to be presented to the patient can be selected from a preestablished list of questions associated with a particular disease state or the list of questions can be manually created using the patient clinical pathway page. The present invention also contemplates that the questions be presented in a decision tree fashion with the branch to be followed depending on the answer provided to a previous question. The question decision tree can also be preestablished or manually created using this page. Default answers, the type of answers expected, and thresholds for such answers can also be set. Thresholds are used to send alerts to the healthcare professional via alert area 154 in medical data summary page 146. For example, if the patient is asked how he or she feels, an alert threshold can be set so that if he or she answers “poorly” or “very poorly,” an alert is provided in alert area 154. In this manner, the patient can provide timely information to the healthcare professional with a minimal amount of effort on the part of the professional.

FIG. 5M illustrates a patient reminders page 200 that includes a reminders table 202. Reminders 204 entered into reminders table 202 are presented to the patient according to a reminder schedule 206 also contained in table 202. In this manner, the medical information management system of the present invention provides reminders to a patient, for example by signaling an audio or visual reminder alarm on patient interface appliance 44, prompting the patient to comply with the prescribed treatment. The content and scheduling of such reminders can be readily altered via table 202.

FIGS. 6A, and 6B illustrate an example of a display presentation tailored for use when an authorized third party interacts with the medical information management system of the present invention. When using a conventional internet compatible computer terminal, such as computer terminal 58 of FIG. 3, to access the medical information management system, the third party is first presented with a start page, generally similar to start page 74 of FIG. 5A. If the third party enters an authentic username and password, a third party main page 208 is presented. See FIG. 6A. Third party main page 208 somewhat similar to healthcare professional main page 88 in that it includes a header field 210, an advertisement field 212, a patient observation active field 214 for reviewing the medical information of a patient, as well as informational fields 216 and 218 for reviewing general medical information. Of course, other fields and links can be provided.

Patient observation active field 214 is an abbreviated version of patient management center active field 90 in that only a subset of information available to the healthcare professional via patient management center active field 90 is available to the third party via patient observation active field 214. More specifically, patient observation active field 214 preferably includes only information believed to be relevant to third party caregivers, who are laymen with little or no medical knowledge. In the embodiment illustrated in FIG. 6B, patient observation active field 214 includes a patient data summary link 220 and a patient treatment plan link 221.

Actuating patient data summary link 220 causes a patient data summary page 222 to be displayed. See FIG. 6B. Patient data summary page 222 is somewhat similar to patient data summary page 146 presented to a healthcare professional, except that, in one embodiment of the present information, page 222 does not include all of the information that is displayed to the healthcare professional. In another embodiment of this invention, the manner in which the information is displayed, i.e., the presentation format, is different from the manner or format in which the information is displayed to the healthcare professional. For example, information otherwise included in patient data summary page 146 in the healthcare professional tailored presentation is specifically omitted from patient data summary page 222 in the third party tailored presentation or displayed in a summarized form to make it easier for the third party to review and comprehend the patient's medical information.

In the illustrated embodiment, patient data summary page 222 includes a non-compliance area 224 that corresponds to non-compliance area 156 discussed above and a health trend area 226 that corresponds to health trend area 152 discussed above. A further embodiment of the present invention contemplates including patient biographical information, such as that shown in FIG. 5E, or a portion of that information, because this information, especially the patient's physician information, may be useful to the third party caregiver should the patient suffer a medical emergency.

Actuating patient treatment plan link 221 in patient observation active field 214 of third party main page 208 causes a patient treatment plan page to be displayed. Preferably, the patient treatment plan presented to the third party caregiver does not include technical medical details presented to the healthcare professional in patient treatment plan page 172, so that a layman third party can readily understand the patient treatment plan.

Details of the operation of patient interface appliance 44 are discussed below with reference to FIGS. 2, 3, 4, 7A-7G, 8 and 9. In particular, FIGS. 7A-7G illustrate an example of dedicated patient interface appliance 44 for use with the medical information management system of the present invention and a portion or sample of patient tailored display presentation 48 provided on patient appliance 44. FIGS. 8 and 9 illustrate algorithms carried out by the patient interface appliance in providing the patient tailored presentation.

As noted above, according to one embodiment of the present invention, patient interface appliance 44 runs a preprogrammed processing routine stored in memory 49 for displaying patient-tailored presentation 48 in the form of a series of pages provided on display 50. In a preferred embodiment of the present invention, patient-tailored presentation includes 48 providing a patient survey, as discussed above, on the display. The patient survey is preferably a wellness survey to determine the well-being of the patient and/or a survey to determine whether or to what extent the patient is complying with the prescribed therapy. The survey consists of a series of questions presented to the patient. The patient provides responses to these questions via an input device, and the responses are collected in memory 49.

According to one embodiment of the present invention, this is all done offline, meaning the patient interface appliance does not directly interact with medical information management center 32 at that time. Periodically, however, patient appliance 44 synchronizes with server 34 through communication network 46 for transmitting the patient responses to server 34, so that the patient's medical condition, as represented by these responses, can be monitored by the medical information management system via the medical information management center. During this temporary on-line interaction between patient interface appliance 44 and medical information management center 32, the information stored in memory 49 can also be updated by the server.

FIG. 8 illustrates an algorithm 228 for operating the patient interface appliance according to the principles of the present invention. This algorithm is stored in memory 49 and executed by processor 47 when a patient manually activates appliance 44, for example, by depressing any input key or by turning the unit on using a dedicated switch or keypad stroke. The algorithm can also be executed automatically by having the appliance activate itself. This may be desirable, for example, where it is important to provide a reminder to a patient or to request that the patient periodically conduct the patient survey.

When executed, algorithm begins with a start step 230, and enters a main page display step 232 in which a main page 234 is provided in display 50. See FIG. 7A. Main page 234 is preferably an introductory screen that notifies the user that the unit is operating and presents the user with possible alternative user selectable options for using the patient interface appliance.

In an exemplary embodiment of the present invention, main page 234 includes a general information field 236, which includes a text field 237 and a menu field 238 for presenting user selectable options. Main page 234 also includes an advertisement field 240. The information provided in general information field 236, including user selectable options, is generated based in information display commands stored in memory 49, and the advertisement presented in advertisement field 240 is generated based on an advertisement display command also stored in memory 49. Of course, the message and user selectable options presented in general information field 236 and the advertisements provided in advertisement field 240 can be periodically altered, for example, from new commands provided by the medical information management center.

Each individual selection in menu field 238 is aligned with a button 242 located on housing 45 so that the patent can select a menu selection by actuating the associated button. Patient interface appliance 44 also includes an LED 244 that preferably is lit when appliance 44 is actuated, and arrow keys 246 for use in scrolling through the text in display 50, for example.

In the illustrated embodiment, menu field 232 includes a contact information selection 248, a health information selection 250, a patient store selection 252, and a patient survey selection 254. Contact information selection 248, when selected, causes the appliance to display contact information that the patient can use to contact a medical device provider, for example, in the event of equipment failure or if a part, such as a nasal mask, needs replaced. Health information selection 250 displays health information provided by the healthcare professional via the patient education feature discussed above. It is to be understood that medical related information can also be provided from other sources, such as the company maintaining the medical information management system.

Patient store selection 252 provides an e-commerce portal allowing the patient to purchase products, such a refills for their medication, using appliance 44. Finally, patient survey selection 254 provides the patient access to questionnaires or surveys for accessing the patient's well being or other purposes. For example, the company maintaining the medical information management system may present a survey regarding the ease of use of patient interface appliance 44 as well as the wellness-type surveys discussed above.

Referring again to FIG. 8, in step 256, processor 47 determines whether button A has been actuated. As shown in FIG. 7A, button A is associated with a contact information selection 248, for displaying contact information in the general information field. If input A is actuated, step 258 causes the contact information, which includes information for contacting at a healthcare professional, a medical service provider, and a medical product provider, for example, to be displayed. Thereafter, the routine returns to 232 to display main page 238. This allows a user to quickly retrieve the necessary information regarding their caregivers.

In step 260, processor 47 determines whether button B has been actuated. Button B, in this embodiment, is associated with a health information selection 250 for displaying general medical information in the general information field. If input B is actuated, step 262 causes the general medical information to be displayed. The present invention contemplates that this information can be any medical information.

In step 264, processor 47 determines whether button C has been actuated. Button C, in this embodiment, is associated with patient store selection 272 in FIG. 7A. If button C is actuated, step 266 displays information used to review and/or order a product and service. In effect, step 266 provides an e-commerce function allowing the patient to review products and services and to order these items by transmitting the order to the medical information management center 34 the next time a communication link to the medical information management center is established.

It is to be understood that other options or steps for displaying information or controlling the presentation on information and user selection options can be performed within steps 258, 262, and 266. For example, in step 258 the user can be presented with a contact information page from which the user selects the specific type of contact information to be viewed. In step 262, the user can be presented with an index on medical information from which the user selects the desired topic. In step 266, the user can be presented with general categories of products and services from which to browse and shop. These additional steps and subroutines are omitted from the figures for the sake of brevity and because there are a potentially infinite variety of steps or subroutines can be provided within steps 258, 262, and 266 depending on the desired functions to be available to the user.

In step 268, the processor determines whether button D has been actuated. Button D, in this embodiment, is associated with patient survey selection 254. If button D is actuated, the processor begins the patient survey in step 270. During the patient survey the patient is presented with one or more queries based on the query display commands stored in memory 49. In each query, the patient is directed to answer one or more questions regarding, for example, their medical condition, treatment, or monitoring procedures. Such information may be helpful, for example, in accessing the effectiveness of the current treatment plan and in identifying other potential areas of concern.

These questions may be similar to the questions a physician asks a patient with a certain disease type during an office visit. The patient can also be asked to download data from medical device to the patient interface appliance via medical device terminal 55 as the patient survey or a part of a patient survey. This information, like the information provided by the patient in response to a query, is helpful in monitoring the condition of the patient. However, information from a medical device is advantageous in that is provides an objective indication of the patient's condition.

As noted above, the present invention contemplates that the queries presented to the patient during the patient survey can be selected from a preestablished list of questions associated with a particular disease state or the list of questions can be manually created by a healthcare professional. The present invention also contemplates that the questions be presented in a decision tree fashion, with the branch to be followed depending on the answer provided to a previous question. The question decision tree can also be preestablished or manually created by a healthcare professional. Default answers, the type of answers expected, and thresholds for such answers can also be set. Thresholds are used to send alerts to the healthcare professional. For example, if the patient is asked how he or she feels, an alert threshold can be set so that if he or she answers “poorly” or “very poorly,” an alert is provided to the healthcare professional. In this manner, the patient can provide timely information to the healthcare professional with a minimal amount of effort on the part of the healthcare professional.

FIGS. 7B, 7C, and 7D illustrate a series of exemplary pages presented to a patient when conducting the patient survey or questionnaire. FIG. 7B illustrates an example query page 272 in which a query in the form of a multiple choice question is provided in general information field 236 and an advertisement is provided in advertisement field 240. Each answer to the multiple choice question is presented next to a unique input device 242. As noted above, the questions presented to the patient during a survey session can be in the form of a decision tree, with the each questionnaire page being selected based on the response give in a previous questionnaire page. FIG. 7C illustrates an example of a follow-up multiple choice query page 274 that is presented to the patient if he or she answers the question presented in questionnaire page 272 with the answer “some” or “yes, quite a bit.”

FIG. 7D illustrates a query page 276 that allows the user to provide a quantifiable answer to the question presented. In this example, the patient uses buttons 242 to move an indicating arrow 278 along a continuum 280 to the desired response location.

It is to be understood that FIGS. 7B-7D represent only a few of the myriad of possible question and response presentations that can be presented to the user. These examples are provided, at least in part, to give an example of a presentation that is used in executing step 270 to collect data for later downloading to the medical information management center.

The present invention contemplates that the patient will complete the patient survey each day or as directed by the healthcare professional. To help motivate the patient to complete the patient survey, algorithm 228 includes an optional step 282 that is executed following the completion of the patient survey. In step 282, the processor includes provides a survey completion reward to the user completing the patient survey.

The present invention contemplates a variety of items as the survey completion reward. For example, the processor can provide a user access to an interactive game that is stored in memory 49 and that can be presented on the display. The processor can also register the user in a prize drawing in step 282 as the survey completion regard, with the list of registrations being maintained in the medical information management center and a winner being drawn periodically. The present invention also contemplates awarding the user a predetermined number of credits in step 282 that can be accumulated applied to the acquisition of a good or service. The management of the survey completion rewards, and whether or not they should be issued, and if so, how much, can be handled locally in the patient interface appliance or remotely in the medical information management system depending on the nature of the reward.

It is to be understood that the selectable options in menu field 238 are not limited to those discussed above with respect to steps 256-270 in FIG. 8. Other options can be provided. In general, the number of user selectable options that can be displayed at one time is limited by the number of input devices that can be associated with each selection. However, arrow keys 246 can be used to scroll through additional options.

For example, the present invention contemplates providing a help option that, once selected, provides the user with information on using the patient interface appliance. The present invention also contemplates providing a game options, which is only activated if step 270 is completed. The present invention further contemplates providing a electronic mail option so that the user can review received messages and provide responses or create their own messages. To this end, the present invention contemplates providing a visual indicator, such as LED 244, that is lit to indicate that an incoming message is available for the patient to review. Of course, other audio or visual indicators can be provided for accomplishing this function. For example, display 50 can flash or an icon can be provided in the display for signaling the arrival of the message.

The present invention further contemplates that the patient can review, at least in a summary form, the information provided by that patient to the patient interface appliance, information collected via a monitoring device, or both. This can be done, for example, by presenting the patient with a personal medical summary option.

FIG. 7E illustrates an example of a physiological parameter display page 284 that is provided to the user. This page illustrates the medical data collected over a period of time, which, in this example, is the peak expiratory flow of the patient taken using a spirometer. The medical information is presented in general information field 236 and an advertisement is presented in advertisement field 240. This allows the patient to quickly monitor, at least in a general sense, his or her progress to recovery or his or her success in disease management.

Referring again to FIGS. 3 and 8, in step 286 of FIG. 8, the processor determines whether to establish communication link 38 with medical information management center 32. As noted above, the present invention contemplates that patient interface appliance 44 is not continuously on-line with server 34. Instead, it periodically synchronizes with server 34 through communication network 46. The present invention contemplates that this is done automatically by the appliance at any one of a variety of times, for example, within a certain time period after the patient has provided data into the patient interface appliance, after a predetermined amount of data has be loaded into the appliance, or periodically, such as in the middle of the night or other time when the patient is not using the appliance. Establishing a communication link between patient interface appliance 44 and medical information management center 32 can be manually initiated by an input command from the patient.

If an communication link is to be established, patient interface appliance does so in step 288, which may require prompting the user, for example, to plug communication terminal 57 to a telephone jack if a telephone modem is used as a part the communication link.

Once communication link 36 between patient interface appliance 44 and server 34 is established, server 34 preferably controls the exchange of information during this log-on session. In this manner, a patient interacts, at least indirectly, with the medical information management center. During this on-line interaction, server 34 can download new queries, user selectable options, new advertisements, display information, and so on into memory 49 and can receive the patient response from previously administered patient surveys.

The present invention further contemplates that medical information management system 30 of the present invention can be used to provide reminders to a patient to perform a task. To this end, the patient interface appliance determines in step 290 in FIG. 8 whether a reminder is to be generated. If so, a reminder is provided in step 292. FIG. 7F illustrates an example of such a reminder function, where a reminder page 294 is presented to the patient on the display of patient interface appliance 44, reminding him or her to take their medication at the scheduled time.

In addition to providing a reminder function, the present invention contemplates that the patient interface appliance have a confirmation capability that is used to confirm that the patient took his or her medication, for example. This is accomplished in the presentation of FIG. 7F by prompting the patient to press any key once he or she has taken the medication or complied with the treatment. This can also be accomplished by presenting a query asking the patient if he or she took or medication or used the CPAP therapy, for example. Of course, the present invention contemplates other techniques for confirming that the patient has complied with the prescribed treatment or therapy. For example, a medication dispensing device can be provided that communicates with patient interface appliance 44 to signal when the patient has taken their medication.

Patient interface appliance 44 can execute steps 290 and 292 to generate this reminder without interaction with information management center 32. However, if an ongoing link to the server is maintained, the information management center can prompt the appliance or computer terminal to generate the reminder according the reminder schedule, either in addition to or in place of steps 290 and 292.

Rather than a periodic reminder, as discussed above with respect to FIG. 7F, the present invention also contemplates that the patient appliance or the information management center generate reminders on an as needed basis. For example, a reminder may be issued to remind the patient to comply with a prescribed medical treatment if the collected compliance data indicates that the patient is not acting in accordance with such treatment or to ask the patient if they would like to order a prescription refill when the medical information management center determines that the current prescription is nearly completed and if a refill is authorized. FIG. 7G illustrates an example of such an ad hoc reminder page 296 with a confirmation function, which includes an advertisement field 240 and a text field 236, and prompts to the patient for a “yes” or “no” response.

When not being actively used, patient interface appliance 44 is preferably, although not necessarily, maintained in standby mode. In optional step 298 of FIG. 8, processor 47 determines whether to enter this standby mode. There are a variety of techniques for determining when to enter the standby mode. In one embodiment of the present invention, the processor simply determines if the main page is being displayed, and determines if no inputs have been received for a period of time, such as 5-10 minutes. If so, the processor executes a standby processing routine 300 for maintaining the appliance in the standby mode shown in FIG. 9.

In step 302, a standby page is displayed. This can be a blank page, a screen saver page, or even the main page. In this standby page, the patient interface appliance can also provide any one of a variety of visual or audio indications that the appliance is in the standby mode. For example, the display can flash on and off, have reduced brightness, a standby icon can be displayed, or LED 244 can flash. See FIG. 7A. Other LEDs or providing LED 244 with different colors can also be used to signal that the appliance is in the standby mode.

In step 304, the processor determines if any input device has been actuated. If so, the processor returns to algorithm 228 of FIG. 8. If not, the processor determines in step 306 whether it is time to switch the appliance to the active mode. For example, the present invention contemplates that the patient interface appliance can be used as an alarm clock, maintaining itself in the standby mode until such time as a patient reminder is to be issued, for example, when a patient survey is to be completed. At that time, the appliance determines in step 306 that it is to enter the active mode and the main page is displayed (if different from the standby page) and a visual and/or audio reminder is displayed/sounded, reminding the patient to complete the survey.

It can be appreciated that establishing medical information management system 30 and administering this system above requires a relatively large initial and operating expenditure. To held subsidize these costs, the present invention contemplates providing an advertising field in the display presented to the healthcare professional, the third party, and the patient. See, for example, advertisement field 82 in FIG. 5A, 100 in FIG. 5B, 112 in FIG. 5C, 132 in FIGS. 5D-5M, 212 in FIG. 6A-6B, and 240 in FIG. 7B-7G. The company supervising the information management system and responsible for the content of each page displayed can then sell the use of or access to the advertisement field in one or more of these pages, so that the purchasing entity can display their advertisement to the user accessing the medical information management system via the first, second, or third communication link. It is to be understood, that other advertisement fields, active or otherwise, can be provided. Also, the location, shape, and relative size of the advertisement field is not intended to be limited to that shown in the figures.

By providing both queries and advertisements to the patient, the interface appliance of the present invention allows the manager of the medical information system to generate revenue. These advertisements also provide third parties access to patients using the patient interface appliance. This is beneficial to the third parties in that they can directly promote their products or services and to the patients. This is also beneficial to the patients, because the patients are presented with information, such as product and service ideas, that may be of value and interest. For example, the user of a CPAP system can be presented with advertisements for the latest interface device, i.e., masks, as they are released.

It is to be understood that the present invention is not intended to be limited to the specific presentation information and formats discussed above and shown in the figures. Of importance with respect to the present invention is not the specific information presented on each displayed page in the healthcare professional tailored presentation, the patient tailored presentation, or the third party tailored presentation. What is important, at least with respect to one aspect of the present invention, is that the information content, format, or arrangement presented to a user differs depending on whether the user is a healthcare professional (FIGS. 5A-5M), a third party (FIGS. 5A, 6A-6B), or a patient (FIGS. 7A-7G). Different display presentations are provided in order to optimize the usefulness and user friendliness of the presentation of information to each particular type of user.

It can be appreciated from the foregoing description of the interaction between information management center 32 and a healthcare professional, third party, or patient, that the information management center has the ability to collect and compile information in an ongoing basis, which is important in making sure that a patient complies with their prescribed therapy. For example, as part of a patient's medical treatment regimen, he or she may be asked to report each day whether they took their prescribed medication or used their prescribed therapy device, and, if so, how long, etc. This information can be provided by patient 12 to information management center 32 via first communication link 34 using patient appliance 44 presenting a questionnaire as discussed above or using a computer terminal.

However, a more sophisticated embodiment of the present invention contemplates that such information is provided directly to the information management center by the medical device being used by the patient. For example, a spirometer can be provided with a communication link that allows it to provide the data it collects directly to information management center 32 rather than to patient interface appliance 44.

As noted above, the information or data collected by patient interface appliance 44 can be downloaded to information management center 32 in a real-time basis, at designated times, when a threshold storage capacity of the appliance is reached, or any combination thereof. Establishing a first communication link with the patient interface appliance can be initiated by the appliance itself, either automatically or following a manually input command from the patient, or by the information management center, assuming that a continuous communication link is maintained between the patient interface appliance and the server.

A significant aspect of the medical information management system of the present invention is that it makes it possible for an authorized third party, such as a friend or family member, who would otherwise not have access to the medical information contained in the information management center to have access to this information.

Moreover, the third party access to the medical information contained in the information management center is tailored to meet the needs of that third party. For example, the third party access to the medical information contained in the information management center is done so without providing the high level of detail required of a healthcare professional accessing this system, while providing information beyond that which is typically presented to the patient. This allows the third party to gain a clearer picture of the medical progress of the patient than would otherwise be possible.

It should also be noted that the present invention contemplates that the patent interface appliance described above, and, in particular, the inclusion of advertising on this device and the use of an incentive reward to foster usage of the appliance, can be used of provided in any type of patient management system. These aspects of the present invention can be used in the medical information management system 30 with its unique third-party access capability, or any other information management system.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

What is claimed is:

1. A medical information management system comprising:
an information management center adapted to receive and manage medical information associated with a patient;
a patient appliance having an input/output device, a processor, and a memory, wherein a patient interacts with the patient appliance, via the input/output device according to a patient tailored presentation that is generated by the processor based on data stored in the memory, to provide medical information to the patient appliance, review information stored in the patient appliance, or both;
means for selectively establishing a first communication link between the information management center and a patient appliance assigned to a patient whose medical information is being managed by the information management center for communicating data from the patient appliance to the information management center or from the information management center to the patient appliance;
means for selectively establishing a second communication link between the information management center and a healthcare professional terminal of a healthcare professional supervising a patient whose medical information is being managed by the information management center, wherein interaction between the healthcare professional terminal and the information management center via the second communication link is governed by a healthcare professional-management center protocol so that a healthcare professional interacting with the information management center via the healthcare professional terminal is provided with a healthcare professional tailored presentation different from the patient tailored presentation; and
means for selectively establishing a third communication link between the information management center and a third party terminal of a third party authorized by a patient whose medical information is being managed by the information management center to allow such a third-party access to at least a portion of the medical information associated with such a patient for reviewing same, wherein interaction between such a third party terminal and the information management center via the third communication link is governed by a third party-management center protocol, so that a third party interacting with the information management center via the third party terminal to review the medical information associated with a patient is provided with a third-party tailored presentation different from the patient tailored presentation and different from the healthcare professional tailored presentation.

2. A medical information system according to claim 1, wherein the first communication link, the second communication link, or the third communication link is an internet based communication link, a telephone based communication link, a LAN communication link, or a WAN communication link.

3. A medical information system according to claim 1, wherein the information management center includes:
means for periodically receiving patient information provided by the patient appliance via the first communication link;
means for processing the periodically received patient information; and
means for automatically providing a notification to at least one of a patient, a healthcare professional, and a third party responsive to one of 1) a patient failing to provide the patient information, and 2) the patient information falling outside a predetermined threshold.

4. A medical information system according to claim 1, wherein the information management center includes:
means for preparing a summary of the medical information managed by the information management center; and
means for providing the summary to at least one of 1) a patient via the first communication link, 2) a healthcare professional via the second communication link, and 3) an authorized third party via the third communication link.

5. A medical information system according to claim 1, wherein the information management center includes means for providing reminders to at least one of a patient, a healthcare professional, and an authorized third party instructing a patient to at least one of 1) comply with a prescribed therapy or treatment, and 2) perform a monitoring function.

6. A medical information system according to claim 1, wherein the information management center includes a database adapted to store at least one 1) general medical information not specific to the medical information associated with a patient and 2) location information indicating where such general medication information is located, and wherein at least one of a patient and a third party can access at least one of the general medical information and the location information via the first communication link and the second communication link, respectively.

7. A medical information system according to claim 1, wherein the third party tailored presentation, the patient tailored presentation or the healthcare professional party tailored presentation includes a first field in which the patient information is displayed and a second field in which an advertisement is displayed.

8. A medical information system according to claim 1, at least one the means for establishing a first communication link, means for establishing a second communication link, and means for establishing a third communication link includes a voice synthesizing capability so that information can be communicated orally via at least one of the first, second, and third communication links.

9. A medical information system according to claim 1, wherein at least one the means for establishing a first communication link, means for establishing a second communication link, and means for establishing a third communication link also allows for an associated patient, healthcare professional, and third party to select a communication medium by which information is provided.

10. A medical information system according to claim 1, wherein the patient appliance further comprises means for providing a providing a positive pressure therapy to a patient.

11. A method of managing medical information comprising:
providing an information management center adapted to receive and manage medical information associated with a patient;
providing a patient appliance having an input/output device, a processor, and a memory, so that a patient interacts with the patient appliance, via the input/output device according to a patient tailored presentation that is generated by the processor based on data stored in the memory, to provide medical information to the patient appliance, review information stored in the patient appliance, or both.
selectively establishing a first communication link between the information management center and the patient appliance assigned to a patient whose medical information is being managed by the information management center for communicating data from the patient appliance to the information management center or from the information management center to the patient appliance;
selectively establishing a second communication link between the information management center and a healthcare professional terminal of a healthcare professional supervising a patient whose medical information is being managed by the information management center, wherein interaction between the healthcare professional terminal and the information management center via the second communication link is governed by a healthcare professional-information management center protocol so that a healthcare professional interacting with the information management center via the healthcare professional terminal is provided with a healthcare professional tailored presentation different from the patient tailored presentation; and
selectively establishing a third communication link between the information management center and a third party terminal of a third party authorized by a patient whose medical information is being managed by the information management center to allow such a third party access to at least a portion of the medical information associated with such a patient for reviewing same, wherein interaction between such a third party terminal and the information management center via the third communication link is governed by a third party-management center protocol so that a third party interacting with the information management center via the third party terminal to review the medical information associated with a patient is provided with a third-party tailored presentation different from the patient tailored presentation and different from the healthcare professional tailored presentation.

12. A method according to claim 11, further comprising:
periodically receiving, at the information management center, patient information via the first communication link;
processing the periodically received patient information; and
automatically providing a notification to at least one of a patient, a healthcare professional, and a third party responsive to one of 1) a patient failing to provide the patient information, and 2) the patient information falling outside a predetermined threshold.

13. A method according to claim 11, further comprising:
preparing a summary of the medical information managed by the information management center; and
providing the summary to at least one of 1) a patient via the first communication link, 2) a healthcare professional via the second communication link, and 3) an authorized third party via the third communication link.

14. A method according to claim 11, further comprising providing reminders to at least one of a patient, a healthcare professional, and an authorized third party instructing a patient to one of 1) comply with a prescribed therapy or treatment, and 2) perform a monitoring function.

15. A method according to claim 11, further comprising:
storing at least one 1) general medical information not specific to the medical information associated with a patient and 2) location information indicating where such general medication information is located;
providing a patient access to the general medical information and the location information via the first communication link; and
providing a third party access to the general medical information and the location information via the third communication link.

16. A method according to claim 11, further comprising providing a first field in which the patient information is displayed and a second field in which an advertisement is displayed in the third party tailored presentation, the patient tailored presentation or the healthcare professional party tailored presentation.

17. A method according to claim 11, further comprising providing the information management center with a voice synthesizing capability so that information can be communicated orally via at least one of the first, second, and third communication links.

18. A method according to claim 11, further comprising:
receiving a communication medium instruction from at least one of a patient via the first communication link, a healthcare professional via the second communication link, and a third party via the third communication link; and
communicating information to at least one of a patient, a healthcare professional, and a third party via a communication medium designated by the communication medium instruction.

19. A method according to claim 11, further comprising providing a providing a positive pressure therapy to a patient via the patient appliance.

20. A patient interface appliance comprising:
a housing;
at least one input device associated with the housing for providing input information to the patient interface appliance responsive to a patient manually actuating the input device;
a display provided on the housing;
a processor within the housing and adapted to receive the input information from the input device and to control a presentation of information provided on the display such that the display includes a general information field and an advertisement field;
a memory associated with the processor for storing data including: (1) query display commands to display a plurality of queries pertaining to a patient's medical condition in the general information field presented in a patient survey, (2) the input information entered via the input device in response to a query, and (3) an advertisement display command to display an advertisement in the advertisement field; and
information transferring means associated with the processor and memory for communicating information from the patient interface appliance to a medical information management center.

21. A patient interface appliance according to claim 20, further comprising an audio output device operatively coupled to the processor and adapted to generate an audio output based on a signal from the processor.

22. A patient interface appliance according to claim 20, further comprising a visual indicator associated with one of the housing and the display and adapted to provide a visual indicator to a user that at least one of the following conditions exist: (1) the patient interface appliance in a stand-by mode, and (2) a message is available for review via the display.

23. A patient interface appliance according to claim 20, wherein the display commands include a main page display command to display a main page, which includes a plurality of user selectable options, in the general information field, wherein one of the plurality of user selectable options is a start patient survey option for initiating the patient survey in which the plurality of queries are presented in the general information field and responses to the queries are received via the input device.

24. A patient interface appliance according to claim 23, remaining other of the plurality of user selectable options include at least one of the following:
(1) a contact information display option for displaying contact information in the general information field for contacting at least one of a healthcare professional, a medical service provider, and a medical product provider;
(2) a general medical information display option for displaying general medical information in the general information field; and
(3) a catalog information display for displaying information used to order at least one of a product and service.

25. A patient interface appliance according to claim 20, wherein the processor includes means for providing a survey completion reward to a user responsive to completing the patient survey.

26. A patient interface appliance according to claim 25, wherein the survey completion reward includes at least one of: (1) access to an interactive game presented on the display, (2) registration in a prize drawing, and (3) accumulation of a predetermined number of credits that can be applied to the acquisition of a good or service.

27. A patient interface appliance according to claim 20, wherein the processor establishes a communication link with the information management center via the communication terminal for at least one of:
(1) downloading to the information management center the input information entered via the input device;
(2) modifying the display commands; and
(3) modifying the advertisement display commands.

28. A patient interface appliance according to claim 20, further comprising a medical equipment terminal disposed on the housing and operatively coupled to the processor to allow data to be downloaded to the processor from an external medical device.

29. A patient interface appliance according to claim 20, further comprising a pressure generator adapted to receive a supply of breathing gas and produce a flow of breathing gas at a pressure above ambient atmospheric pressure.

30. A patient interface appliance comprising:
a housing;
inputting means for providing input information to the patient interface appliance from a user;
outputting means, disposed on the housing, and having a display area for providing visual indicia to a user;
processing means for receiving the input information from the inputting means and for controlling the outputting means such that the display includes a general information field and an advertisement field;
storing means for storing data including at least one of: (1) query display commands to display a plurality of queries pertaining to a patient's medical condition in the general information field presented in a patient survey, (2) the input information entered via the inputting means in response to a query, and (3) an advertisement display command to display an advertisement in the advertisement field; and
means for communicating the data stored in the storing means with a medical information management center.

31. A patient interface appliance according to claim 30, further comprising means for generating an audio output based on a signal from the processing means.

32. A patient interface appliance according to claim 30, wherein the storing means also stores a message from an external source to be provided to a user, and further comprising means for notifying a user that the message is available for review.

33. A patient interface appliance according to claim 30, further comprising means for providing a survey completion reward to a user responsive to such a user completing the patient survey.

34. A patient interface appliance according to claim 30, further comprising means for communicating data from an external medical device to the processing means.

35. A patient interface appliance according to claim 30, further comprising pressure generating means for producing a flow of breathing gas at a pressure above ambient atmospheric pressure for delivery to an airway of a patient.

36. A method of monitoring a patient, comprising:
(1) providing a patient interface appliance comprising:
a housing,
at least one input device associated with the housing,
a display disposed on the housing adapted to include a general information field and an advertisement field,
a processor disposed within the housing,
a memory associated with the processor, and
information transferring means, associated with the processor and memory, for communicating information from the patient interface appliance;
(2) storing in the memory:
query display commands to display a plurality of queries pertaining to a patient's medical condition in a general information field of the display in a patient survey,
input information entered via the input device in response to a query, and
an advertisement display command to display an advertisement in an advertisement field of the display;
(3) displaying an advertisement in the advertisement field based on the advertisement display command;
(4) displaying a patient survey comprising a plurality of queries in the general information field based on the query display commands;
(5) receiving input information from the patient via the input device for each query; and
(6) transmitting the input information response to a medical information management center via the information transferring means.

37. A method according to claim 36, wherein transmitting the input information response includes at least one of:
automatically establishing a communication link with the medical information management center responsive to an occurrence of a predetermined event, and
establishing the communication link responsive to a user manually actuating the input device; and
transmitting the input information to the medical information management center responsive the communication link being established.

38. A method according to claim 36, further comprising:
establishing a communication link with the medical information management center; and
at least one of (1) modifying the display commands, and (2) modifying the advertisement display commands based on information provided by the information management center.

39. A method according to claim 36, further comprising:
storing in the memory a message from an external source; and
providing one of a visual indication and an audio indication that the message stored in the memory is available for review.

40. A method according to claim 36, further comprising providing a user with a survey completion reward responsive to a such user completing the patient survey.

41. A method according to claim 40, wherein providing such a user with a survey completion reward includes at least one of:
(1) providing access to an interactive game for presentation on the display,
(2) registering such a user in a prize drawing, and
(3) awarding such a user a predetermined number of credits that can be applied to the acquisition of a good or service.

42. A method according to claim 36, further comprising communicating data from an external medical device to the patient interface appliance for transmission to the medical information management center.

43. A method according to claim 36, further comprising generating a flow of breathing gas at a pressure above ambient atmospheric pressure for delivery to an airway of a patient.

44. A patient interface appliance comprising:
a housing;
at least one input device associated with the housing for providing input information to the patient interface appliance responsive to a user manually actuating the input device;
a display provided on the housing;
a processor within the housing and adapted t o receive the input information from the input device and to control a presentation of information provided on the display;
a memory associated with the processor for storing data including: (1) query display commands to display a plurality of queries pertaining to a patient's medical condition presented in a patient survey, (2) the input information entered via the input device in response to a query, wherein the processor executes the patient survey, in which a user is prompted to provide a response to a query or to provide requested information, and wherein the processor provides a user with a survey completion reward responsive to a such user completing the patient survey; and
information transferring means associated with the processor and memory for communicating information from the patient interface appliance to a medical information management center.

45. A patient interface appliance according to claim 44, wherein the patient a survey comprises a plurality of queries presented on the display and the survey completion reward is provided only if a response is provided to each of the plurality of queries.

46. A patient interface appliance according to claim 44, wherein the survey completion reward includes at least one of (1) access to an interactive game for presentation on the display, (2) registration in a prize drawing, and (3) accumulation of a predetermined number of credits that can be applied to the acquisition of a good or service.

47. A patient interface appliance according to claim 44, further comprising a pressure generator adapted to receive a supply of breathing gas and produce a flow of breathing gas at a pressure above ambient atmospheric pressure.

48. A patient interface appliance comprising:
a housing;
inputting means for providing input information to the patient interface appliance from a user;
outputting means, disposed on the housing, and having a display area for providing visual indicia to a user;
processing means for (a) receiving the input information from the inputting means, (b) controlling a presentation of information provided on the displaying means such that a main menu is displayed on the displaying means from which a user can chose to execute a patient survey, in which a user is prompted to provide a response to a query or to provide requested information, and (c) providing a user with a survey completion reward responsive to such a user completing the patient survey;
means for storing data including: (1) a query display command to display the query pertaining to a patient's medical condition presented in the patient survey, (2) the input information entered via the input device in response to the query; and
means for communicating the data stored in the storing means with a medical information management center.

49. A patient interface appliance according to claim 48, wherein the processing means displays a plurality of queries in the patient surface and the survey completion reward is provided only if a response is provided to each of the plurality of queries.

50. A patient interface appliance according to claim 48, wherein the survey completion reward includes at least one of (1) access to an interactive game for presentation on the display, (2) registration in a prize drawing, and (3) accumulation of a predetermined number of credits that can be applied to the acquisition of a good or service.

51. A patient interface appliance according to claim 48, further comprising pressure generating means for producing a flow of breathing gas at a pressure above ambient atmospheric pressure for delivery to an airway of a patient.

52. A method of monitoring a patient, comprising:
(1) providing a patient interface appliance comprising:
a housing,
at least one input device associated with the housing,
a display disposed on the housing adapted to include a general information field and an advertisement field,
a processor disposed within the housing,
a memory associated with the processor, and
information transferring means, associated with the processor and memory, for communicating information from the patient interface appliance;
(2) storing in the memory:
query display commands to display a plurality of queries pertaining to a patient's medical condition in a patient survey, and
input information entered via the input device in response to a query;
(3) displaying a patient survey comprising a plurality of queries in the general information field based on the query display commands;
(4) receiving input information from the patient via the input device for each query; and
(5) providing a user with a survey completion reward responsive to completion of the patient survey.

53. A method according to claim 52, further comprising transmitting the input information to a medical information management center via the communication terminal.

54. A method according to claim 52, providing a user with a survey completion reward includes at least one of (1) providing access to an interactive game for presentation on the display, (2) registering the user in a prize drawing, and (3) accumulating a predetermined number of credits that can be applied to the acquisition of a good or service.

55. A method according to claim 52, further comprising generating a flow of breathing gas at a pressure above ambient atmospheric pressure for delivery to an airway of a patient.

56. A method of subsidizing costs associated with compiling and maintaining a medical information management system, comprising:
a) providing a medical information management system comprising:
1) a patient appliance having an input/output device, a processor, and a memory, wherein a patient interacts with the patient appliance via the input/output device according to a patient tailored presentation that is generated by the processor based on data stored in the memory to at least one of 1) provide medical information to the patient appliance and 2) reviewing information stored in the patient appliance;
2) means for selectively establishing a first communication link between the information management center and a patient appliance assigned to a patient whose medical information is being managed by the information management center for communicating data from the patient appliance to the information management center;
3) means for selectively establishing a second communication link between the information management center and a third party terminal of a third party authorized by a patient whose medical information is being managed by the information management center to allow such a third-party access to the medical information associated with such a patient for reviewing same, wherein interaction between the third party terminal and the information management center via the second communication link is governed by a third party-management center protocol so that a third party interacting with the information management center via the third party terminal is provided with a third-party tailored presentation different from the patient tailored presentation and different from the healthcare professional tailored presentation;
b) providing a first advertisement field in the third-party tailored presentation or the patient tailored presentation; and
c) selling use of the first advertisement field for displaying an advertisement therein.

57. A method according to claim 56, further comprising:
d) providing a second advertisement field in the other of the patient tailored presentation and the third-party tailored presentation; and
e) selling use of the second advertisement field for displaying an advertisement therein.

58. A method according to claim 56, wherein the medical information management system comprising further comprises means for selectively establishing a third communication link between the information management center and a healthcare professional terminal of a healthcare professional supervising a patient whose medical information is being managed by the information management center, wherein interaction between the healthcare professional terminal and the information management center via the third communication link is governed by a healthcare professional-management center protocol so that a healthcare professional interacting with the information management center via the healthcare professional terminal is provided with a healthcare professional tailored presentation different from the patient tailored presentation and different from the third-party tailored presentation, and further comprising:
f) providing a third advertisement field in the healthcare professional tailored presentation; and
e) selling use of the third advertisement field for displaying an advertisement therein responsive to the caregiver accessing the medical information management system via the third communication link.
